(19) United States
(12) Patent Application Publication
(10) Pub. No.: US 2025/0235784 A1
(43) Pub. Date: Jul. 24, 2025

(54) PROGRAM, INFORMATION PROCESSING SYSTEM, AND INFORMATION PROCESSING METHOD

(71) Applicant: CYGAMES, INC., Tokyo (JP)

(72) Inventors: Tomoya Taguchi, Tokyo (JP); Yuki Tomizawa, Tokyo (JP); Seiya Kamizato, Tokyo (JP); Naoyuki Takahashi, Tokyo (JP)

(73) Assignee: CYGAMES, INC., Tokyo (JP)

(21) Appl. No.: 19/174,459

(22) Filed: Apr. 9, 2025

Related U.S. Application Data
(63) Continuation of application No. PCT/JP2023/035895, filed on Oct. 2, 2023.

(30) Foreign Application Priority Data
Oct. 31, 2022 (JP) 2022-174531

(51) Int. Cl. A63F 13/533; A63F 13/49; A63F 13/63

(52) U.S. Cl. CPC A63F 13/533; A63F 13/49; A63F 13/63

(57) ABSTRACT

Provided are a program, an information processing system, and an information processing method that serve to improve convenience concerning experience of game rendition. The following units are included: a raising-function providing unit that provides a raising function for presenting selection candidates for instructing an action of a game medium being raised among the game media, determining a rendition execution pattern on the basis of a condition associated with an action selected by the player, and executing game rendition; and a rendition-viewing-function providing unit that provides a rendition viewing function for letting the player select the game medium and the rendition execution pattern and for executing the game rendition on the basis of the results of selection. The rendition-viewing-function providing unit presents the rendition execution patterns randomly determined with the raising function as selection candidates, allowing the player to arbitrarily select the rendition execution pattern.

### CROSS-REFERENCE TO RELATED APPLICATIONS

This application is a continuation of International Patent Application No. PCT/JP2023/035895, having an international filing date of Oct. 2, 2023, which designated the United States, the entirety of which is incorporated herein by reference. Japanese Patent Application No. 2022-174531 filed on Oct. 31, 2022 is also incorporated herein by reference in its entirety.

### BACKGROUND OF THE INVENTION

The present invention relates to programs, information processing systems, and information processing methods for games in which a game medium is raised.

There has hitherto been a known type of game in which a raising function for raising a game medium, such as a character, is provided, an action of the game medium is instructed for each single turn with the raising function, and game rendition based on the result of the action of the game medium is performed (see Publication of Japanese Patent No. 7146039). With a game having such a raising function, experiencing game rendition based on the results of actions of a game medium is one of the funs of playing the game for a player.

However, even in the case where the same action is instructed to a game medium being raised, there are cases where the rendition execution pattern is determined randomly, such as the case where there is a branch pattern for the result of the action. Thus, for the player to experience game rendition for all rendition execution patterns, the player may have to consume a huge amount of time; for example, a need for repeatedly playing the game arises.

### SUMMARY OF THE INVENTION

The present invention has been made in view of the situation described above, and it is an object thereof to provide a program, an information processing system, and an information processing method that serve to improve convenience concerning experience of game rendition.

According to a first aspect of the disclosure, there is provided a program for a game in which game media are raised, the program causing a computer to function as:
a raising-function providing unit that provides a raising function for presenting selection candidates for instructing an action of a game medium being raised among the game media, determining a rendition execution pattern on the basis of a condition associated with an action selected by the player, and executing game rendition; and
a rendition-viewing-function providing unit that provides a rendition viewing function for letting the player select the game medium and the rendition execution pattern and for executing the game rendition on the basis of the results of selection,
wherein the rendition-viewing-function providing unit presents the rendition execution patterns randomly determined with the raising function as selection candidates, allowing arbitrary selection by the player from among the rendition execution patterns.

According to a second aspect of the disclosure, there is provided an information processing system for a game in which game media are raised, the information processing system comprising:
a raising-function providing unit that provides a raising function for presenting selection candidates for instructing an action of a game medium being raised among the game media, determining a rendition execution pattern on the basis of a condition associated with an action selected by the player, and executing game rendition; and
a rendition-reproducing-function providing unit that provides a rendition viewing function for letting the player select the game medium and the rendition execution pattern and for executing the game rendition on the basis of the results of selection,
wherein the rendition-viewing-function providing unit presents the rendition execution patterns randomly determined with the raising function as selection candidates, allowing arbitrary selection by the player from among the rendition execution patterns.

According to a third aspect of the disclosure, there is provided an information processing method for a game in which game media are raised, the information processing method comprising:
a raising-function providing step of providing a raising function for presenting selection candidates for instructing an action of a game medium being raised among the game media, determining a rendition execution pattern on the basis of a condition associated with an action selected by the player, and executing game rendition; and
a rendition-viewing-function providing step of providing a rendition viewing function for letting the player select the game medium and the rendition execution pattern and for executing the game rendition on the basis of the results of selection,
wherein, in the rendition-viewing-function providing step, the rendition execution patterns randomly determined with the raising function are presented as selection candidates, allowing arbitrary selection by the player from among the rendition execution patterns.

### BRIEF DESCRIPTION OF DRAWINGS

FIG. 1 is a diagram showing the overall configuration of an information processing system.

FIG. 2 is a functional block diagram of a server, relating to a raising function and a rendition viewing function among functions realized by the information processing system.

FIG. 3 is a functional block diagram of a player terminal, relating to the raising function and the rendition viewing function among the functions realized by the information processing system.

FIG. 4 is a flowchart showing an example process relating to the raising function for raising a character.

FIG. 5 is an illustration showing an example character-to-raise selection screen displayed at the player terminal.

FIG. 6 is an illustration showing an example character-to-inherit selection screen displayed at the player terminal.

FIG. 7 is an illustration showing an example character-to-inherit list screen displayed at the player terminal.

FIG. 8 is an illustration showing an example character-to-inherit selection screen displayed at the player terminal.

FIG. 9 is an illustration showing an example character-to-inherit selection screen displayed at the player terminal.

FIG. 10 is an illustration showing an example support configuration screen displayed at the player terminal.

FIG. 11 is an illustration showing an example final confirmation screen displayed at the player terminal.

FIG. 12 is an illustration showing an example raising home screen displayed at the player terminal.

FIG. 13 is an illustration showing an example training screen displayed at the player terminal.

FIG. 14 is an illustration showing an example screen displayed while game rendition is being executed, displayed at the player terminal.

FIG. 15 is an illustration showing an example screen displayed while game rendition is being executed, displayed at the player terminal.

FIG. 16 is an illustration showing an example race list screen displayed at the player terminal.

FIG. 17 is an illustration showing an example raising home screen displayed at the player terminal.

FIG. 18 is an illustration showing an example race list screen displayed at the player terminal.

FIG. 19 is an illustration showing an example target-accomplishment notification screen displayed at the player terminal.

FIG. 20 is an illustration showing an example target list screen displayed at the player terminal.

FIG. 21 is an illustration showing example state transitions relating to the rendition viewing function for viewing game rendition.

FIG. 22 is an illustration showing an example photo-library top screen displayed at the player terminal.

FIG. 23 is an illustration showing an example main-character selection screen displayed at the player terminal.

FIG. 24 is an illustration showing an example rendition-part selection screen displayed at the player terminal.

FIG. 25 is an illustration showing an example training-detail selection screen displayed at the player terminal.

FIG. 26 is an illustration showing an example training-detail selection screen displayed at the player terminal.

FIG. 27 is an illustration showing an example partner selection dialog displayed at the player terminal.

FIG. 28 is an illustration showing an example going-out/event-detail selection screen displayed at the player terminal.

FIG. 29 is an illustration showing an example screen displayed while game rendition is being executed, displayed at the player terminal.

FIG. 30 is an illustration showing an example image confirmation screen displayed at the player terminal.

FIG. 31A and FIG. 31B are an illustration showing an example confirmation dialog displayed at the player terminal.

### DETAILED DESCRIPTION OF THE INVENTION

(1) The present embodiment relates to a program for a game in which game media are raised, the program causing a computer to function as: a raising-function providing unit that provides a raising function for presenting selection candidates for instructing an action of a game medium being raised among the game media, determining a rendition execution pattern on the basis of a condition associated with an action selected by the player, and executing game rendition; and a rendition-viewing-function providing unit that provides a rendition viewing function for letting the player select the game medium and the rendition execution pattern and for executing the game rendition on the basis of the results of selection, wherein the rendition-viewing-function providing unit presents the rendition execution patterns randomly determined with the raising function as selection candidates, allowing arbitrary selection by the player from among the rendition execution patterns.
(2) In the program according to the present embodiment, the rendition-viewing-function providing unit may provide an input interface for capturing a screenshot of the game rendition being executed with the rendition viewing function, making it possible to save the captured screenshot image.
(3) In the program according to the present embodiment, it may be possible to select the game medium that serves as a main element and the game medium that serves as a sub-element as the game media that appear in the game rendition executed with the rendition viewing function; and a first condition for permitting selection as the main element and a second condition for permitting selection as the sub-element may be set in association with each of the game media.
(4) The present embodiment relates to an information processing system for a game in which game media are raised, the information processing system including: a raising-function providing unit that provides a raising function for presenting selection candidates for instructing an action of a game medium being raised among the game media, determining a rendition execution pattern on the basis of a condition associated with an action selected by the player, and executing game rendition; and a rendition-reproducing-function providing unit that provides a rendition viewing function for letting the player select the game medium and the rendition execution pattern and for executing the game rendition on the basis of the results of selection, wherein the rendition-viewing-function providing unit presents the rendition execution patterns randomly determined with the raising function as selection candidates, allowing arbitrary selection by the player from among the rendition execution patterns.
(5) The present embodiment relates to an information processing method for a game in which game media are raised, the information processing method including: a raising-function providing step of providing a raising function for presenting selection candidates for instructing an action of a game medium being raised among the game media, determining a rendition execution pattern on the basis of a condition associated with an action selected by the player, and executing game rendition; and a rendition-viewing-function providing step of providing a rendition viewing function for letting the player select the game medium and the rendition execution pattern and for executing the game rendition on the basis of the results of selection, wherein, in the rendition-viewing-function providing step, the rendition execution patterns randomly determined with the raising function are presented as selection candidates, allowing arbitrary selection by the player from among the rendition execution patterns.

With the above-described program, information processing system, and information processing method according to the present embodiment, a rendition viewing function is provided separately from a raising function. With the rendition viewing function, rendition execution patterns randomly determined with the raising function are presented as selection candidates, allowing arbitrary selection by the player from among the rendition execution patterns. This makes it possible for a player to quickly experience, with the rendition viewing function, game rendition unexperienced with the raising function. Therefore, the present embodiment serves to improve convenience concerning experience of game rendition.

The following describes an embodiment of the present invention. Note that the embodiment described below does not unduly limit the content of the invention recited in the claims. Furthermore, all the elements described in the context of the embodiment are not necessarily indispensable constituting requirements of the present invention.

### 1. Configuration of Information Processing System

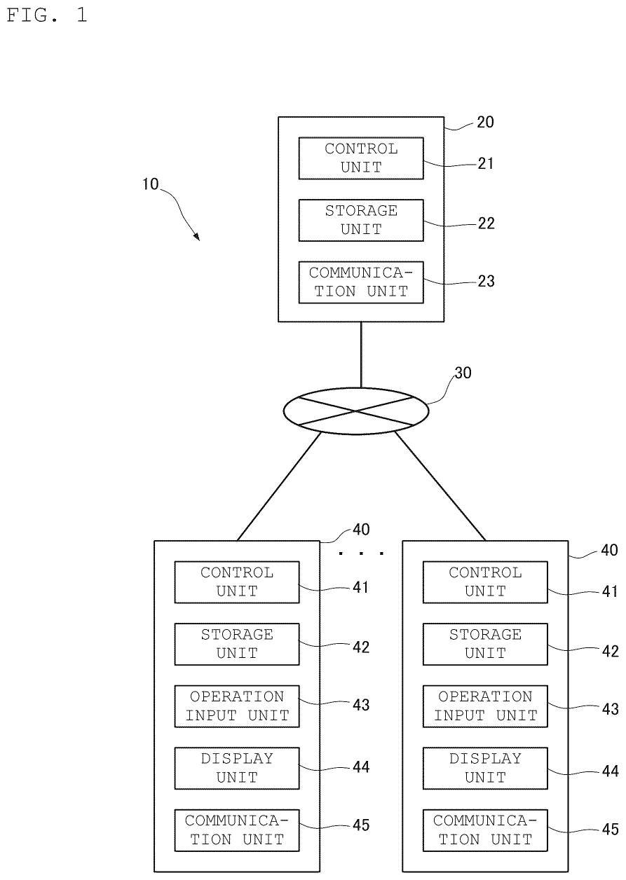

FIG. 1 is a diagram showing the overall configuration of an information processing system 10 in this embodiment. As shown in FIG. 1, in the information processing system 10, a server 20 and a plurality of player terminals 40 are connected via a network 30 such as the Internet, a mobile phone network, a LAN, or a WAN, whereby what is called a client-server communication system is constructed. Furthermore, each of the plurality of player terminals 40 transmits and receives various kinds of information by mutually carrying out communication with the server 20 via the network 30. Furthermore, each of the plurality of player terminals 40 transmits and receives various kinds of information by mutually carrying out communication with the other player terminals 40 via the network 30 and the server 20.

The server 20 includes a control unit 21 implemented by a processor such as a CPU, a storage unit 22 implemented by a main storage device such as a ROM or a RAM and an auxiliary storage device such as an HDD or an SSD, and a communication unit 23 implemented by a communication module or a communication interface. In the server 20, the control unit 21 executes various kinds of processing according to programs stored in the storage unit 22. Furthermore, the server 20, by means of the communication unit 23, receives information from the player terminals 40 and transmits information such as information concerning the results of processing executed by the control unit 21 to the player terminals 40.

The player terminals 40 are smartphones, tablets, personal computers, portable game machines, stationary game machines installed in shops or households, etc. Each of the player terminals 40 includes a control unit 41 implemented by a processor such as a CPU, a storage unit 42 implemented by a main storage device such as a ROM or a RAM and an auxiliary storage device such as a flash memory, an HDD, or an SDD, an operation and input unit 43 implemented by a touch panel, a keyboard, a microphone, or the like, a display unit 44 implemented by a liquid crystal display, an organic EL display, or the like, and a communication unit 45 implemented by a communication module or a communication interface. Each of the player terminals 40 also executes various kinds of processing according to programs stored in the storage unit 42. Furthermore, each of the player terminals 40, by means of the communication unit 45, receives information from the server 20 and transmits information to the server 20 and the other player terminals 40.

The information processing system 10 in this embodiment provides, via the player terminals 40, a game of raising a character whose motif is a racehorse. In particular, the information processing system 10 in this embodiment has a raising function for raising a character, a rendition viewing function for viewing game rendition, and so forth. The following describes the case where these functions are realized with each of the player terminals 40 as the subject. Alternatively, the functions mentioned above may be realized with the server 20 as the subject or may be realized by being shared between the server 20 and each of the player terminals 40. Note that in this embodiment, although not described in detail, as game functions other than the raising function and the rendition viewing functions already mentioned, the information processing system 10 also has a name-card creating function for creating a player's name card presenting profile information of a player, a battle function for letting a raised character play a battle in a race with other characters, a live appreciating function for appreciating live singing by a character, etc.

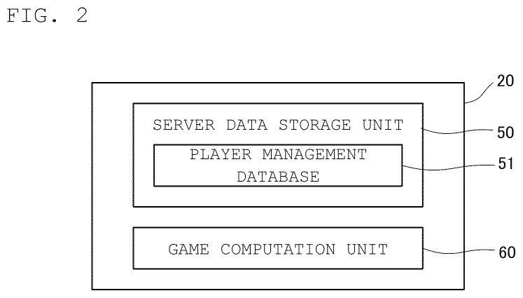

FIG. 2 is a functional block diagram showing main functions of the server 20.

The server 20 in the information processing system 10 has a function for managing players, characters, etc. on the basis of various kinds of identification information and a function for performing computations necessary for the progress of the game in response to requests from the player terminals 20 and transmitting the results of the computations to the player terminals 40. These functions are realized by a server data storage unit 50 and a game computation unit 60 in cooperation with each other.

The server data storage unit 50 includes a player management database 51, which is realized mainly by the storage unit 22. In this embodiment, character lists, item lists, raising subject lists, etc. are stored in the player management database 51 in association with player IDs assigned to individual players.

A character list includes, for example, character individual IDs assigned to individual raised characters, character kind IDs indicating the kinds of the characters, the statuses (rarity, evaluation score, course aptitude, distance suitability, running style suitability, race strategy, speed, stamina, power, spirit, wisdom, possessed skills, and acquired titles) of the characters, the lock states (locked or not locked), raising histories (raising conditions, and the records of races participated in during raising) of the characters, etc.

In this embodiment, a “raised character” refers to a character that has been raised by means of the raising function, which is one of the game functions realized by the information processing system 10 in this embodiment, and whose statuses have been fixed as a result of completion of the raising thereof.

Furthermore, “character individual IDs” and “character kind IDs” are provided in this embodiment, which differ from each other as follows.

First, a “character individual ID” is an ID that is assigned when the raising of a character by means of the raising function has been finished and the resulting raised character is registered in the player management database 51. “Character individual IDs” are used to identify individual raised characters associated with a player ID.

Furthermore, in this embodiment, the arrangement is such that the player selects a raising subject from a plurality of kinds of characters with the raising functions. “Character kind IDs” are IDs that are assigned in order to identify the kinds of raised characters.

Furthermore, the “lock state” indicates whether or not transfer (deletion from a character list) of a raised character is prohibited. Transfer is permitted if the raised character is not locked, and transfer is not permitted if the raised character is locked. Situations in which a raised character becomes locked include the case where the player has individually specified the raised character from a list of raised characters, the case where the raised character is registered for participation in a race, etc.

A raising subject list stores data in which information indicating released or not yet released is associated with each character kind ID. In this embodiment, characters having information indicating released associated therewith in the raising subject list serve as characters that can be selected as a raising subject by a player with the raising function. Furthermore, in this embodiment, it is possible to newly release a character with a releasing item or through a character acquiring lottery, and the number of characters that can be selected by the player as a raising subject varies. Hereinafter, there are cases where characters that can be selected as a raising subject with the raising function are referred to as released characters.

An item list includes data concerning items, enhancement points, and an in-game currency possessed by a player. In this embodiment, for example, the content and number of items possessed, the amount of enhancement points possessed, the amount of the in-game currency possessed, etc. are stored in the player management database 51 in the form of an item list.

An item in this embodiment, for example, supports raising of a character or is used for purposes such as changing conditions for participating in a race. An item can be acquired depending on the result of a race or can be acquired by consuming the in-game currency.

Furthermore, enhancement points are used, for example, for purposes such as enhancing a support item, which is an item for supporting raising of a character, and it becomes possible to raise a character in a more advantageous environment as a support item is enhanced.

Furthermore, the data stored in the player management database 51 includes friend lists. In this embodiment, it is possible to register other players as friends and to use, with the raising function, characters and support items rented from the other players registered as friends. When registering a friend, the player ID of another player is input in a friend registration screen displayed on the display unit 44 of the player terminal 40, and in the case where the player corresponding to the player ID exists and it is possible to register the player as a friend, a tap input to a registration button provided in the friend registration screen is performed, whereby the player ID of the other player to be registered is added to the friend list. There is an upper limit (e.g., 50) to the number of friends that can be registered by each player, and there is also an upper limit (e.g., 100) to the number of players who can register each player as a friend. Thus, it is possible to newly register a friend in a situation where neither upper limit has been reached.

The game computation unit 60 performs processing for performing computations necessary for the progress of the game in response to requests from the player terminals 20 and transmitting the results of the computations to the player terminals 40, processing or transmitting data necessary for the progress of the game to the player terminals 40 in response to requests from the player terminals 20, etc. The game computation unit 60 is realized mainly by the control unit 41 and the communication unit 45. As an example, when a request concerning a training instruction has been received with the raising function from one of the player terminals 20, the game computation unit 60 computes a result indicating either a success or a failure of training, and the result of the computation is transmitted to the player terminal 40. As another example, when a request concerning participation in a race has been received with the raising function, the game computation unit 60 simulates running in a race among a plurality of characters including a raising subject character and non-player characters (NPCs) and transmits the result of the running simulation to the player terminal 40.

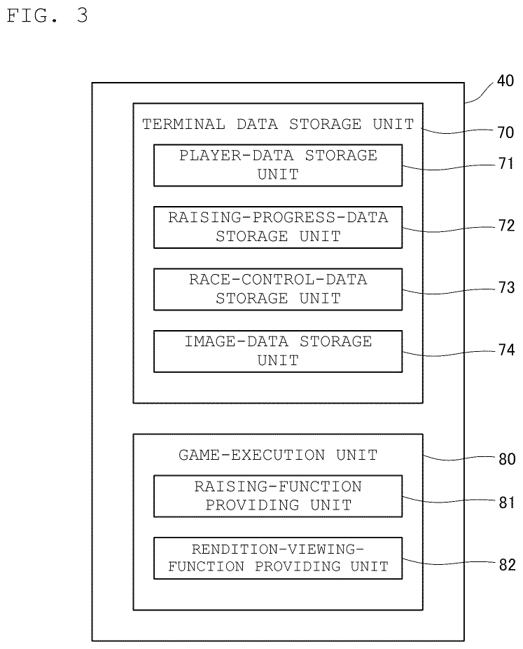

FIG. 3 is a functional block diagram showing main functions of each of the player terminals 40.

As shown in FIG. 3, in each of the player terminals 40 in the information processing system 10 in this embodiment, a terminal data storage unit 70 and a game execution unit 80 cooperate with each other to realize the raising function, the rendition viewing function, etc.

The terminal data storage unit 70 stores data for the game execution unit 80 to perform various kinds of processing and is realized mainly by the storage unit 42.

The terminal data storage unit 70 includes a player-data storage unit 71, and the player-data storage unit 71 stores data concerning a character list, a raising subject list, an item list, a friend list, etc. corresponding to the player ID. In this embodiment, when an application is started and is closed, and in other necessary situations, synchronization processing concerning the data associated with the player ID (the character list, the raising subject list, the item list, and the friend list) is performed between the player-data storage unit 71 of the player terminal 40 and the player management database 51 of the server 20, and various kinds of game processing is executed by using the data stored in the player-data storage unit 71. In this embodiment, in the case where it has become necessary to change the character list, the raising subject list, the item list, or the friend list as various kinds of game processing are executed, the content stored in the player-data storage unit 71 is updated, and the content stored in the player management database 51 of the server 20 is backed up, whereby the content stored in the player-data storage unit 71 and the content stored in the player management database 51 are synchronized. Note that the data associated with the player ID, such as the character list, the raising subject list, the item list, and the friend list, may be downloaded from the player management database 51 to the player-data storage unit 71 as necessary, for example, when an application is started.

Furthermore, the terminal data storage unit 70 includes a raising-progress-data storage unit 72, and the raising-progress-data storage unit 72 stores data necessary for the progress of the raising function (raising progress data) for a character that can be selected as a raising subject with the raising function (a character having a character kind ID having information indicating released associated therewith in the raising subject list). In this embodiment, concerning the raising function, raising targets, game events, etc. are prepared for individual characters, and raising progress data at least including the content of settings for raising targets and the content of settings for game events are stored in the raising-progress-data storage unit 72 in association with character kind IDs.

Furthermore, the raising-progress-data storage unit 72 stores various kinds of data for executing game rendition that occurs with the raising function during the process of raising a character. For example, as rendition material data for executing game rendition, the raising-progress-data storage unit 72 stores base body data representing the shape of the base body of a character, costume data representing the shape of a costume for the character, texture data specifying the colors of the character and the costume, motion data defining character motion, effect data for invoking effects in accordance with the motion of the character as well as the status of progress of rendering, background data corresponding to scenes of game rendition, etc. In this embodiment, the rendition material data stored in the raising-progress-data storage unit 72 are data used with both the raising function and the rendition viewing function.

Furthermore, the raising-progress-data storage unit 72 stores a factor information database, and the factor information database stores information such as factor names, factor levels, and factor types in association with factor registration IDs. Factor information is information that is associated with a raised character in the case where a character has been raised with the raising function. In this embodiment, when a character is raised with the raising function, on the basis of factor information associated with a raised character selected as a character to inherit, a factor inheritance event occurs as a game event for reinforcing statuses that influence abilities of the raising subject character, such as increasing a skill acquisition level or increasing a performance parameter.

Factor information includes four lineages, namely, blue factors, red factors, unique factors, and white factors. Each item of factor information has a factor level set to one of three levels, and a merit more advantageous for status reinforcement is acquired as the factor level becomes higher. Furthermore, factor types specifically classify blue factors, red factors, unique factors, and white factors. A blue factor is factor information having the name of a performance parameter and influences the performance parameter, and the amount of increase in the performance parameter becomes greater as the factor level becomes higher. A red factor is factor information having the name of a course suitability, a distance suitability, or a running style suitability and influences the course aptitude, the distance suitability, or the running style suitability, and the suitability is more likely to increase in a factor inheritance event as the factor level becomes higher. A unique factor is factor information having the name of a unique skill and makes it possible to acquire a unique skill of an inherited character, and it becomes easier to increase the acquisition level of the unique skill as the factor level becomes higher. The acquisition level of a skill influences the amount of skill points consumed when acquiring the skill, and the amount of skill points consumed decreases as the acquisition level becomes higher. A white factor is factor information that does not belong to any of blue factors, red factors, and unique factors, and white factors include skill factors, race factors, and scenario factors. A skill factor is factor information having the name of a skill and makes it easier to increase the acquisition level of a normal skill (a skill that is not a unique skill), and skill factors exist for individual kinds of skills. A race factor is factor information having the name of a race or a racetrack and makes it easier to increase at least one of a performance parameter and the acquisition level of a normal skill, and the merit thereof varies depending on the type of the race or the type of the racetrack. A scenario factor is factor information having the name of a raising scenario and is factor information relating to a raising scenario used to raise a character. In the case where a scenario factor is inherited in a factor inheritance event, it is possible to considerably increase a plurality of performance parameters, and the performance parameters that are increased vary depending on the kind of the scenario factor. Furthermore, according to the factor types mentioned earlier, factor information is classified into six types, namely, blue factors, red factors, unique factors, skill factors, race factors, and scenario factors.

Furthermore, the terminal data storage unit 70 includes a race-control-data storage unit 73, and the race-control-data storage unit 73 stores data for controlling rendition of character motion, skill invocation, etc. when presenting a race in which a character participates with the raising function or the battle function, text data and audio data of race live commentary, etc.

Furthermore, the terminal data storage unit 70 includes an image-data storage unit 74, and the image-data storage unit 74 stores images of screenshots captured with the rendition viewing function. In this embodiment, it is possible to capture a screenshot of game rendition being executed with the rendition viewing function and to save the captured image in the image-data storage unit 74. The screenshot images saved in the image-data storage unit 74 can be viewed at will and can be used with the name-card creating function.

The game execution unit 80 performs processing including: processing for starting the game in the case where a game start condition is satisfied; processing for executing a game mode selected from among a plurality of kinds of game modes; processing for letting the game progress; processing for generating an event in the case where an event generation condition is satisfied; processing for computing a game result; processing for terminating the game in the case where a game termination condition is satisfied; processing for requesting computation to the server 20; processing for obtaining a computation result or necessary data from the server 20; and processing for transmitting a computation result or data at the player terminal 40 to the server 20. The game execution unit 80 is realized mainly by the control unit 41 and the communication unit 45. In this embodiment, the game execution unit 80 includes a raising-function providing unit 81 and a rendition viewing-function providing unit 82.

The raising-function providing unit 81 performs processing for providing the raising function for raising a character. In this embodiment, inputs concerning raising of a character are input, and the results of computations for the inputs are displayed or otherwise used.

In this embodiment, when raising a character with the raising function, it is requested to select an action serving as the subject of turn consumption (hereinafter referred to as a turn consuming action) for each single turn. Turn consuming actions include training, participation in a race, going out, infirmary, etc. The raising-function providing unit 81 accepts selection of a turn consuming action via a raising home screen or the like displayed on the display unit 44 and requests the server 20 to compute the result of the selected turn consuming action. The server 20, upon receiving the request, computes the result of the selected turn consuming action and transmits the result of the computation to the player terminal 40. The raising-function providing unit 81 causes the display unit 44 to display a display screen corresponding to the computation result received from the server 20. In particular, in this embodiment, in the case where training, going out, or infirmary is selected as a turn consuming action, game rendition corresponding to the result of the action is executed on the basis of the computation result received from the server 20. As described above, the raising-function providing unit 81 presents selection candidates for instructing an action of the raising subject character, determines a rendition execution pattern on the basis of a condition associated with an action selected by the player, and executes game rendition.

Furthermore, in this embodiment, a raising target is set in accordance with the kind of the raising subject character, and there are cases where there is an obligatory action, which must forcibly be selected in a prescribed turn for the raising target. The forcible action for the raising target is, for example, participation in a prescribed race or winning a prescribed place as the result of a prescribed race. In this case, in a turn with which a prescribed race associated with the raising target is set, participation in that race is an obligatory action, and it is not possible to select actions for consuming the turn other than participation in the race. As described above, the raising-function providing unit 81 performs control to restrict selection of actions other than an obligatory action in each turn in which selection of the obligatory action is accepted.

The rendition viewing-function providing unit 82 performs processing for providing the rendition viewing function for letting the player select a character and a rendition execution pattern and executing game rendition on the basis of the results of selection. With the rendition viewing function, input of information necessary for reproducing game rendition that is executed in the case where the character is instructed to perform an action classified as training or going out among the turn consuming actions of the raising function is accepted, and the player is allowed to view the game rendition at the discretion of the player. Furthermore, with the rendition viewing function, it is also possible to reproduce game rendition corresponding to a hot-spring trip event, which occurs randomly in the raising process. Note, however, that regarding the hot-spring trip event, released/not yet released is managed on a per-character basis, and it is possible to reproduce the hot-spring trip event with the rendition viewing function only for characters for which the hot-spring trip event has occurred with the raising function. Furthermore, in this embodiment, the rendition viewing-function providing unit 82 presents rendition execution patterns randomly determined with the raising function as selection candidates, which makes it possible for the player to select one of the rendition execution patterns.

Furthermore, it is possible to select a character that serves as a main element and a character that serves as a sub-element as characters that appear in game rendition executed with the rendition viewing function, and each character has associated therewith a first condition for allowing selection as a main element and a second condition for allowing selection as a sub-element. Specifically, it is possible to select a main character that appears as a main element and a training partner that appears as a sub-element as characters that appear in game rendition that occurs in response to a training instruction in the raising process. For the main character, being a released character possessed by the player is set as the first condition, and for the training partner, being a character corresponding to a support item possessed by the player is set as the second condition.

Furthermore, the rendition viewing-function providing unit 82 provides an input interface that makes it possible to capture a screenshot of game rendition being executed with the rendition viewing function and to save the image of the captured screenshot in the image-data storage unit 74. In this embodiment, a capture button is provided in the display screen while game rendition is being executed, and when a tap input is performed on the capture button, the game rendition being executed is paused, and a screenshot is captured. The image of the captured screenshot can be saved at player's will, and when the player has decided to save the image after checking the image, the image of the screenshot is saved in the image-data storage unit 74.

Furthermore, the rendition viewing-function providing unit 82 makes it possible, before saving the screenshot image captured in relation to game rendition being executed with the rendition viewing function in the image-data storage unit 74, to apply filtering processing to the screenshot image. In this embodiment, it is possible to select filtering processing from nine kinds, and it is also possible to save the screenshot image in the image-data storage unit 74 without applying filtering processing.

Furthermore, in the case where the screenshot image having filtering processing applied thereto is saved in the image-data storage unit 74, the rendition viewing-function providing unit 82 also performs processing for saving the unprocessed screenshot image in the image-data storage unit 74 at the time of initial saving.

2. Control Method in this Embodiment

The following describes a control method in this embodiment in the context of an example where a game program in this embodiment is applied to a game application for each of the player terminals 40 provided in the form of a smartphone.

The game program in this embodiment is configured to be able to provide a plurality of kinds of game functions. With the raising function, which is a main game function, a raising subject character is selected from among a plurality of kinds of characters, and when the statuses thereof change as the game progresses and a prescribed finishing condition is satisfied, the statuses of the character are fixed, and raising is finished. With the battle function, which is another game function, the raised character can play a battle in a race with characters raised by other players. Furthermore, in this embodiment, a quota of raised characters (the number of characters that can be registered in the character list) is predetermined, and when an upper limit of the quota (e.g., 240 characters) is reached, it becomes no longer possible to newly raise a character with the raising function. Thus, it becomes necessary to create a quota vacancy by removing raised characters from the character list.

The information processing system 10 to which the game program in this embodiment is applied has the rendition viewing function, which makes it possible for the player to arbitrarily view game rendition that occurs in the process of raising a character with the raising function. Here, as a presupposition for explaining the rendition viewing function, the raising function for raising a character will be explained.

With the raising function, one character that serves as the subject of raising is selected from among a plurality of kinds of characters at the player's will, and the selected character is raised. Each of the plurality of kinds of characters that can be selected as the subject of raising has initial statuses set therefor. Furthermore, the character that serves as the subject of raising has acquired a unique skill corresponding to the kind of the character (unique skill) from the beginning of raising, and the conditions for invoking unique skills and the effects generated when the unique skills are invoked vary individually. Furthermore, each of the plurality of kinds of characters that can be selected as the subject of raising has set therefor growth correction rates for parameters such as speed, stamina, power, spirit, and wisdom depending on the character, and parameters that are easily increased are set for each kind of character.

After a subject of raising is selected and raising of the character is started, it is possible to raise the character by instructing raising in each of 75 turns at most. Specifically, when an instruction for training associated with a performance parameter such as speed, stamina, power, spirit, or wisdom is issued, a change in the performance parameter or the acquisition of skill points occurs in accordance with the result of the training. Furthermore, it is also possible to consume a turn by instructing participation in a race, which makes it possible to change a performance parameter or to acquire skill points in accordance with the result of the race. Furthermore, when an event generation condition is satisfied during raising, an event occurs, whereby the kinds of skills that can be acquired increase or a performance parameter changes. Skill points, which have already been described, are points that are used to let the raising subject character acquire a skill, and it is possible to let the raising subject character acquire a skill from a list of skills that can be acquired by consuming skill points.

Furthermore, in raising a character, a plurality of raising targets are set on a per-character basis in accordance with the kind of the raising subject character. The raising targets include participation in a target race, winning a result within a prescribed place in the target race, acquiring a prescribed number of fans by a specified turn, etc. This embodiment is arranged such that it is possible to acquire a number of fans corresponding to the place as a result of letting the character being raised participate in a race, and a participation condition based on the number of fans is specified depending on the race.

Furthermore, in this embodiment, the plurality of raising targets set on a per-character basis are set in turns up to the 72nd turn, and closing races are held in the 73rd to 75th turns. The closing races are held over three turns, namely, a qualifying race, a semifinal race, and a final race, and it is possible to issue an instruction concerning raising before participation in each race.

Furthermore, in this embodiment, in the case where winning a result within a prescribed place in a target race is set as a raising target in raising a character, a continuation function is provided as a rescue function for the case of a failure to attain a result within the specified place. The continuation function gives an opportunity for retrying the target race, and the player is allowed to retry the target race by consuming a number of continuations given in advance. In this embodiment, the number of continuations is three during raising of a single character.

Furthermore, with the raising game function, a transition to a raising finish confirmation state occurs when one of a plurality of predefined finishing conditions is satisfied.

First, in the case where the final race in the closing races is reached, i.e., in the case where the 75th turn is reached, raising is finished when the final race is finished. In the case where the result of the final race is the 2nd place or worse, it is possible to retry the final race in the case where the number of continuations is remaining. In the case where the result of the final race is the 2nd place or worse after the entire number of continuations is consumed, raising is finished at that timing. Whether or not to use the continuation function is up to the player, and in the case where it is selected not to use the continuation function, raising is finished at that timing.

Furthermore, raising is also finished in the case where the raising target set on a per-character basis has not been attained through turns up to the 72nd turn.

As an example, in the case where the raising target is the acquisition of a prescribed number of fans, raising is finished when the specified number of fans is not reached in a turn set in the raising target. In this case, since it is not possible to use the continuation function, raising is finished when the number of fans has not reached the prescribed number at the timing when the turn for determination has come.

As another example, in the case where the raising target is participation in a target race, the raising target is attained regardless of the place in the race as long as the character participates in the target race. However, each race requires the acquisition of a number of fans serving as a participation condition defined on a per-race basis, and in the case where the number of fans serving as the participation condition for the target race has not been acquired before the turn for that race, it is not possible to participate in the target race, and raising is finished.

As another example, in the case where the raising target is winning a result within a prescribed place in the target race, when the participation condition of the target race is not satisfied, raising is finished at that timing. Even when the character participates in the target race, in the case where a result within the prescribed place was not attained and the number of continuations is no longer remaining, raising is finished. As described earlier, the player can arbitrarily select using the continuation function, and in the case where the number of continuations is remaining but the player has selected not using the continuation function, it is considered that the raising target has not been attained, and raising is finished.

Meanwhile, in the case where raising has progressed to the 73rd or later turn, it is possible to progress to the next turn by winning the first place in each of the qualifying race and the semifinal race in the closing races. In the case where the result was the second place or worse and the number of continuations is no longer remaining, raising is finished. Also in this case, when the player selects not using the continuation function, raising is finished at that timing.

Furthermore, in this embodiment, a transition to the raising finish confirmation state occurs when the condition for finishing raising is satisfied. The raising finish confirmation state gives the last opportunity for acquiring a skill before fixing statuses, and the player can acquire a skill by consuming skill points currently possessed. Furthermore, in the raising finish confirmation state, an input interface for inputting a confirmation of the finish of raising is provided. When the player inputs a confirmation of the finish of raising, the statuses of the raising subject character are fixed, and information concerning the character is registered as a raised character in the character list in the player-data storage unit 71 and the character list in the player management database 51.

When the statuses of the raising subject character are fixed through the raising finish confirmation state, a reward corresponding to the result of raising is awarded. In this embodiment, an amount of the in-game currency, enhancement points, or the like corresponding to the total number of fans acquired by the finish of raising is provided as a reward.

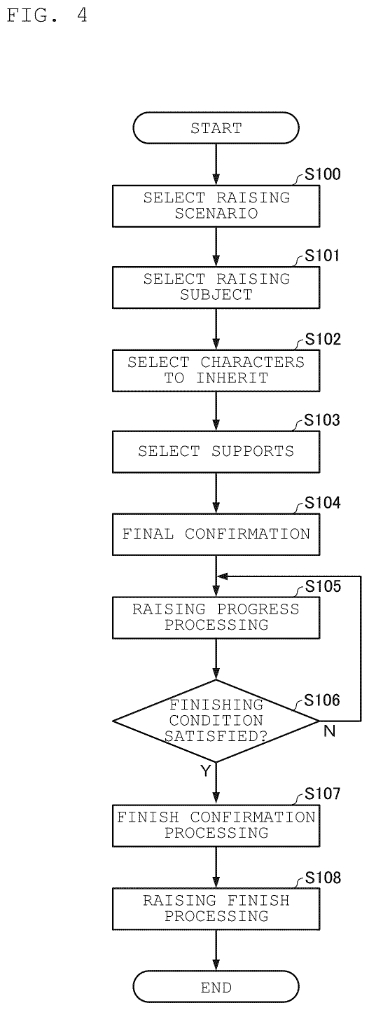

The following explains the progress of the game with the raising function for raising a character in more detail with reference to FIG. 4.

First, before the start of character raising, selection of a raising scenario is accepted (step S100). In this embodiment, a plurality of kinds of raising scenarios are prepared, and the scheme of increasing performance parameters and the scheme concerning skill acquisition vary depending on the selected raising scenario. The raising scenario to be selected can be switched with a swipe input. When an input (e.g., a tap input to an OK button) for determining a raising scenario has been performed, selection of a character to be raised according to the selected raising scenario is accepted (step S101).

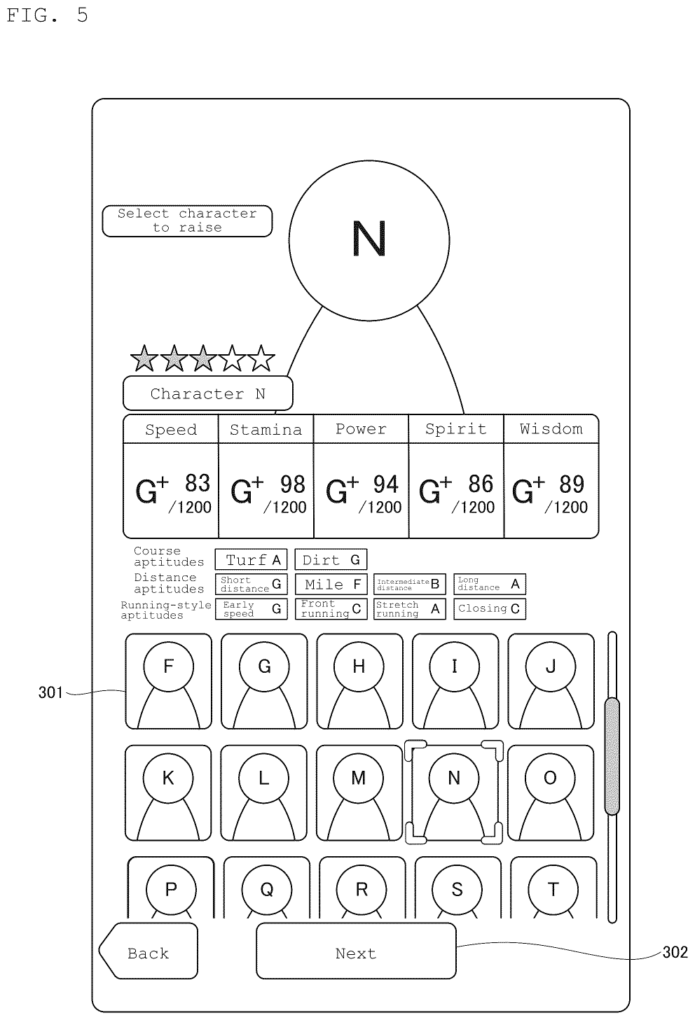

In this embodiment, as shown in FIG. 5, it is possible to select a raising subject by tapping one of character icons 301 for identifying characters in a character-to-raise selection screen. Information concerning characters that can be selected as a raising subject (raisable characters) is managed in a raising subject list in the player-data storage unit 71. The character kind IDs of the raisable characters are obtained from the raising subject list, and the character-to-raise selection screen is displayed. In the character-to-raise selection screen, it is possible to confirm information indicating the initial statuses of the character currently selected. In this embodiment, as the initial statuses, it is possible to confirm the following information in the character-to-raise selection screen: performance parameters (speed, stamina, power, spirit, and wisdom), course aptitudes (turf and dirt), distance suitabilities (short distance, mile, intermediate distance, and long distance), and running style suitabilities (early speed, front running, stretch running, and closing).

When a tap input to a next button 302 has been performed in the state where the character icon 301 of a raising subject character is selected in the character-to-raise selection screen shown in FIG. 5, the display screen changes to a character-to-inherit selection screen, and selection of characters to inherit is accepted (step S102).

This embodiment is arranged such that the player can select two raised characters raised in the past as characters to inherit in newly raising a character and can reinforce the statuses of character to be raised on the basis of the factor information associated with the two selected characters to inherit (information acquired by the characters to inherit during raising thereof).

In this embodiment, the status reinforcement of the raising subject character based on the factor information is performed at the start of raising and in a factor inheritance event that occurs in a prescribed turn after the start of raising. In the case where a factor inheritance event occurs during raising of a character with the raising function, an event result request is transmitted from the player terminal 40 to the server 20. Upon receiving the event result request, the server 20 executes a factor inheritance lottery on the basis of the factor information associated with the two characters to inherit and transmits the result of the lottery to the player terminal 40. Upon receiving the result of the lottery, the player terminal 40 performs status reinforcement of the raising subject character on the basis of the result of the lottery, such as increasing performance parameters or increasing skill acquisition levels, and executes display processing for conveying the result of the status reinforcement through the factor inheritance event to the player.

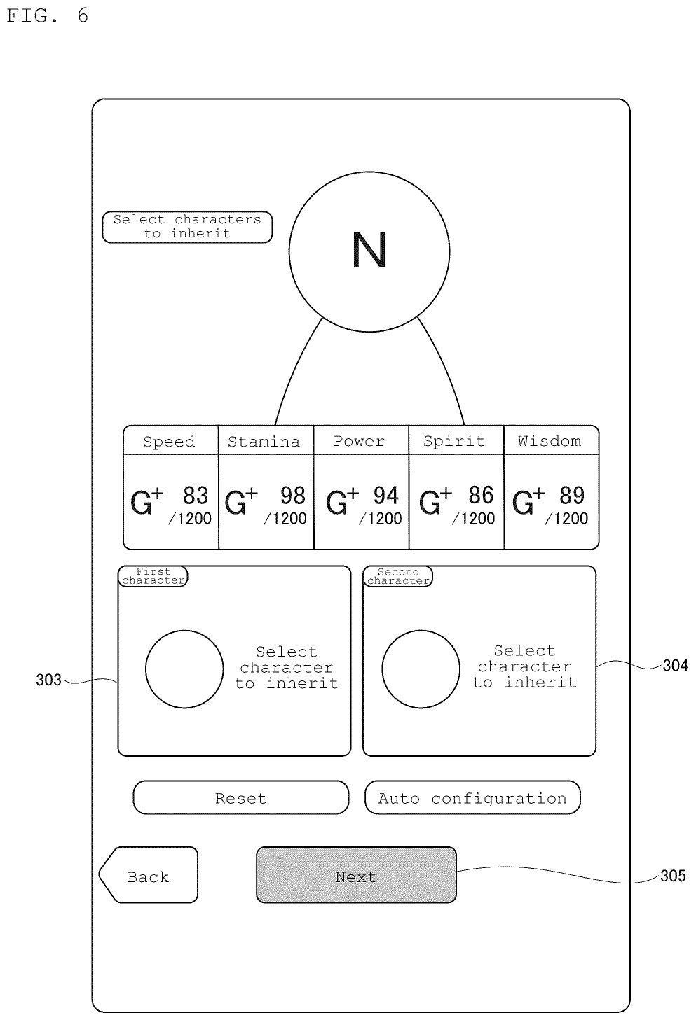

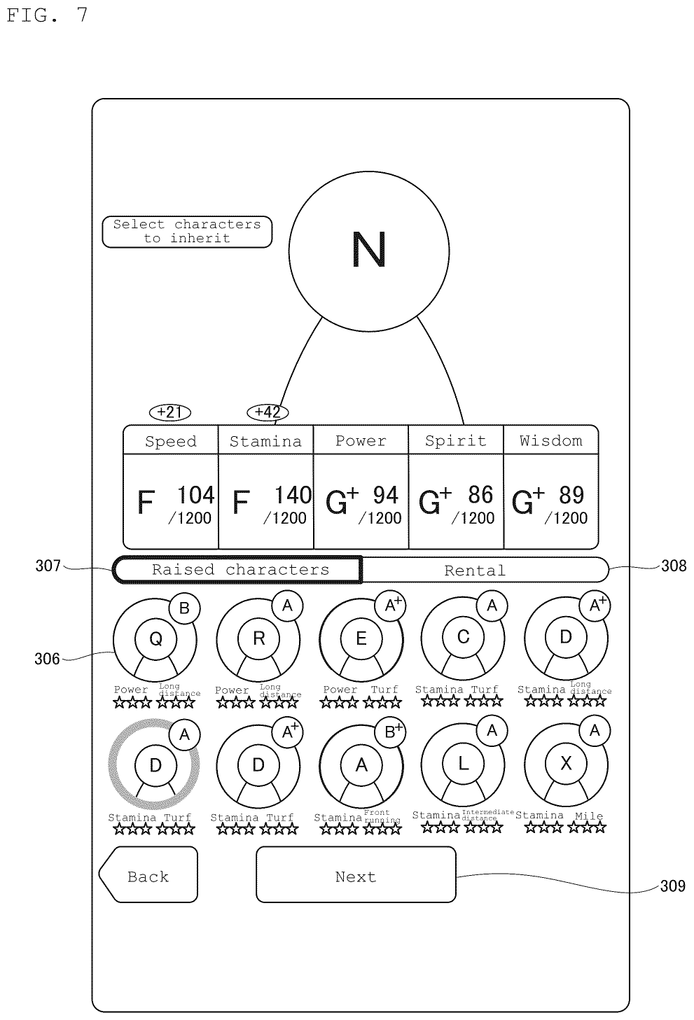

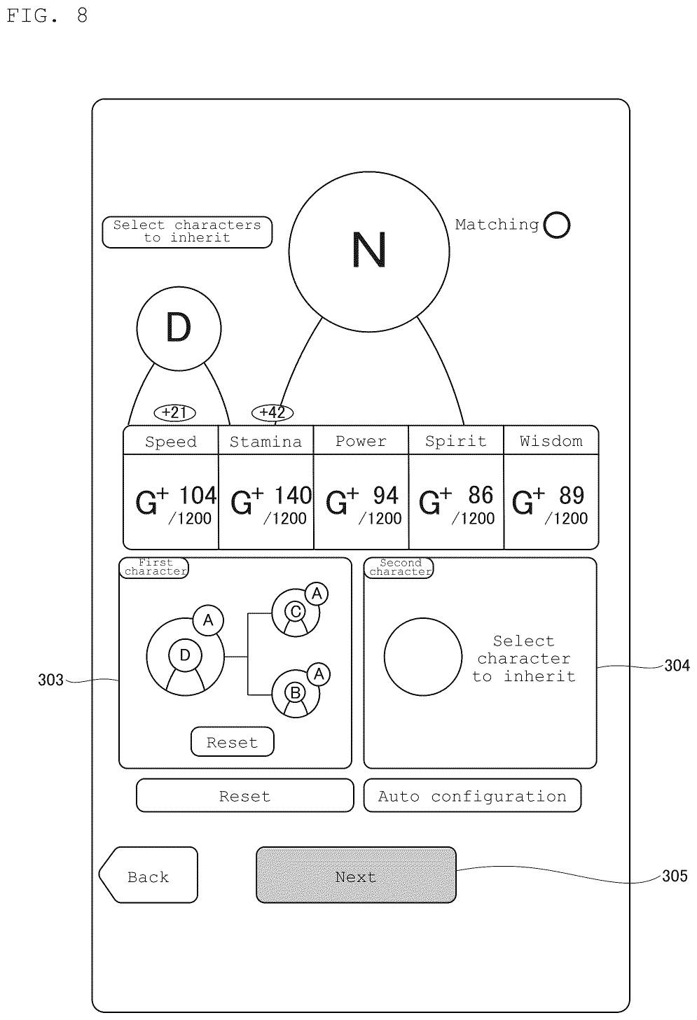

When selecting characters to inherit, a list of characters to inherit that can be selected by performing a tap input to an inheritance frame 303 or an inheritance frame 304, provided for two characters, is displayed. When a tap input to the inheritance frame 303 (or the inheritance frame 304) has been performed in the character-to-inherit selection screen shown in FIG. 6, a character-to-inherit list screen is generated and displayed with reference to the raised character list (a character to inherit list) with reference to the character list in the player-data storage unit 71, as shown in FIG. 7. In the character-to-inherit list screen, it is possible to select a character by performing a tap input on one of character icons 306. When a tap input has been performed on a next button 309 in the state where one of the characters to inherit is selected, the display screen returns to the character-to-inherit selection screen, as shown in FIG. 8.

Furthermore, in selecting characters to inherit, it is also possible to rent and use raised characters raised by other characters registered as friends by the player, as well as raised characters raised by the player himself or herself. In this embodiment, it is possible to rent a raised character raised by another character three times at most per day. In the character-to-inherit list screen shown in FIG. 7, a raised character tab 307 and a rental tab 308 are provided. When a tap input has been performed on the rental tab 308, a rental-character acquisition request is transmitted to the server 20. Upon receiving the rental-character acquisition request, the server 20 refers to the friend registration information (profile information of other players registered as friends) associated with the player ID of the source of the rental-character acquisition request and transmits, to the player terminal 40, a list of rental characters set in the profile information by the other players registered as friends (rental character list). Then, the player terminal 40 generates and displays a character-to-inherit list screen on the basis of the rental character list received.

Furthermore, in order to start raising of a character, it is necessarily required to select two characters to inherit. In the situation where only one character to inherit is selected, the next button 305 is displayed in a grayed-out manner, as shown in FIG. 8, and it is not possible to proceed with preparation for starting raising of a character.

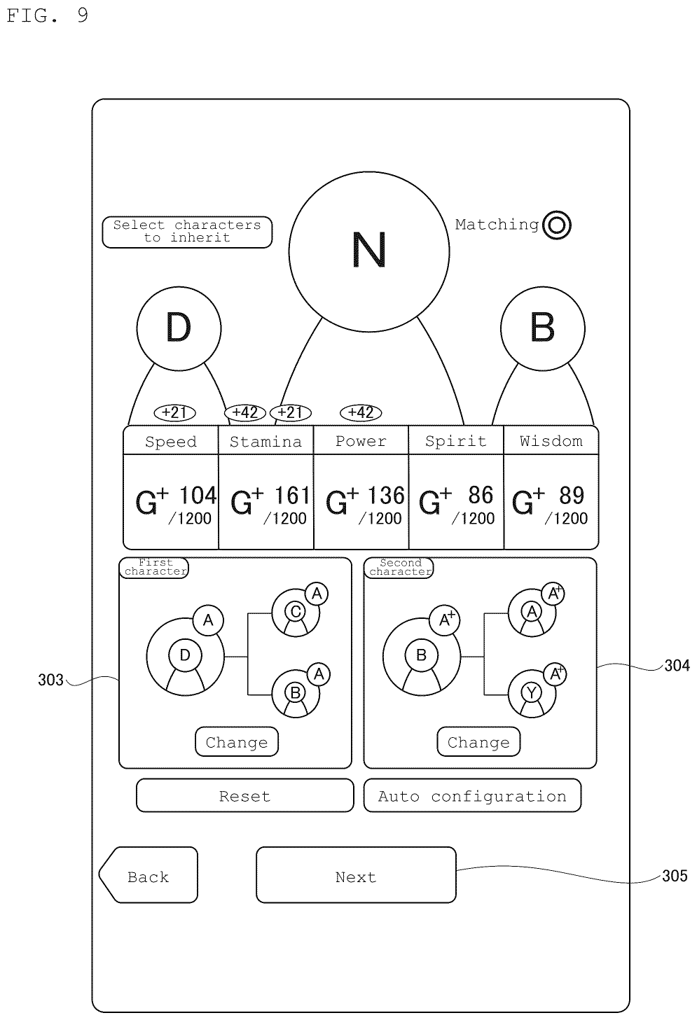

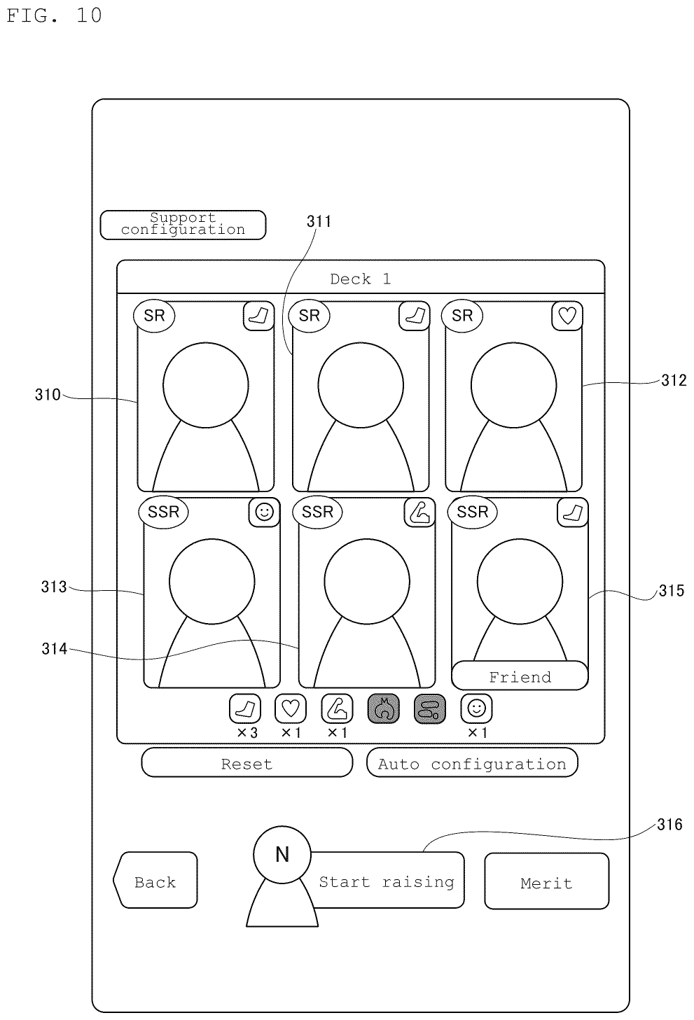

When a tap input to the next button 305 has been performed in the state where two characters to inherit are selected in the character-to-inherit selection screen, as shown in FIG. 9, the display screen changes to a support configuration screen, as shown in FIG. 10, and selection of support items is accepted (step S103).

In this embodiment, support items similar to cards exist as items for supporting raising of a character, and support items make it possible to attain the merit of increasing performance parameters or to increase the kinds of skills that can be acquired. When raising a character, it is possible to incorporate six support items. The arrangement is such that, of the six support items, five are selected from support items possessed by the player himself or herself, and the other one is rented from among support items possessed by other players as a friend's item.

Support items are classified into six lineages depending on the performance thereof, namely, speed, stamina, power, spirit, wisdom, and friend. As for speed, stamina, power, spirit, and wisdom, these items literally exhibit the merit of increasing parameters at the time of training correspondingly to the performance parameters of a character. As for friend, this item exhibits the merit of recovering physical energy, motivation, or the like. The lineages of support items can be distinguished from each other with reference to lineage icons, and the player selects six support items to use in the current raising on the basis of the lineage icons. Furthermore, rare (R), super rare (SR), and special super rare (SSR) exist as three levels of rarity of support items. In this embodiment, rarity becomes higher in order of R<SR<SSR, and basically, the merit of support is higher as the rarity becomes higher.

As shown in FIG. 10, player support frames 310 to 314 for five support items and a friend support frame 315 for one support item are provided in the support configuration screen. When a tap input has been performed on one of the player support frames 310 to 314, a list of support items (player support list) is obtained with reference to the item list in the player-data storage unit 71. Then, a screen displaying a list of support items possessed by the player is generated on the basis of the player support list obtained, and selection of support items is accepted. Furthermore, when a tap input has been performed on the friend support frame 315, a friend-support acquisition request is transmitted to the server 20. Upon receiving the friend-support acquisition request, the server 20 refers to friend registration information associated with the player ID of the source of the friend-support acquisition request and transmits, to the player terminal 40, a list of support items set in the profile information by other players registered as friends (friend support list). The player terminal 40 generates a screen displaying a list of support items that can be set in the friend support frame 315 on the basis of the friend support list received, and selection of a support item is accepted.

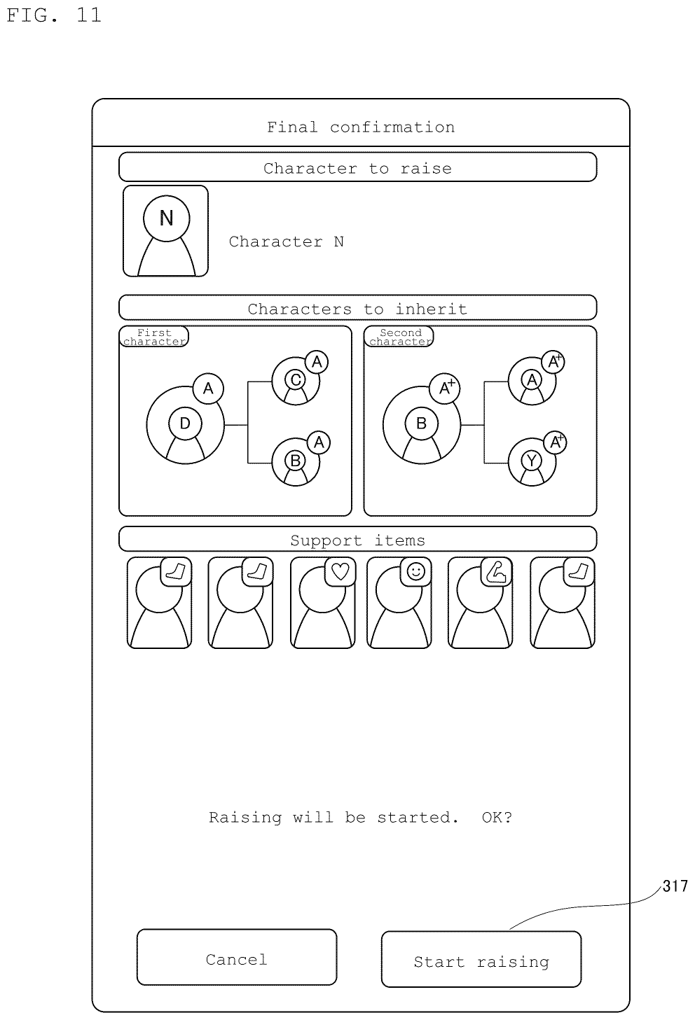

When a tap input to a raising start button 316 has been performed in the state where six support items are incorporated in the support configuration screen, as shown in FIG. 10, the display screen changes to a final confirmation screen, and an input for confirming the start of raising by the player is accepted, as shown in FIG. 11 (step S104). In the final confirmation screen, the raising subject character, the characters to inherit, and the content of support items incorporated, selected by the player, are displayed.

Then, when a tap input on a raising start button 317 has been performed in the final confirmation screen, raising progress processing, in which a character is raised, is performed (step S105). Note that, in this embodiment, when a tap input on the raising start button 317 has been performed in the final confirmation screen in the phase of preparation for starting raising, the raising subject character is set as a default character. The setting of the default character serves to use the default character as an initially selected character in the raising-subject selection screen on the next occasion of raising, which is highly convenient for a player who repeatedly raises the same character.

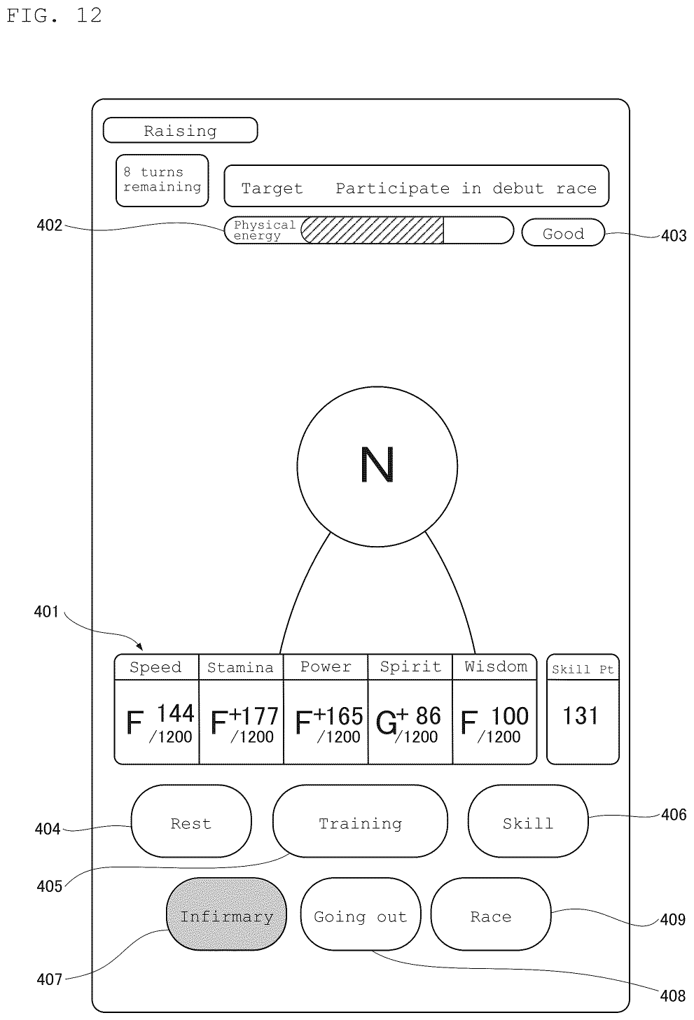

FIG. 12 shows an example raising home screen, which is a kind of screen displayed during raising of a character.

With the function for raising a character in this embodiment, basically, the screen changes from the raising home screen to screens for issuing instructions for various kinds of actions, such as training. In the raising home screen, an animation of the raising subject character is displayed, and a status display field 401 displaying the current statuses (speed, stamina, power, spirit, wisdom, and skill points) of the character is provided.

Furthermore, in the raising home screen, a physical energy gauge 402 and a motivation icon 403 are displayed. The physical energy gauge 402 is a gauge indicating physical energy, which is a parameter that influences the failure rate of training. The physical energy changes with training and race participation during raising as well as game events, etc. that occur during raising. As the physical energy decreases, the possibility of failure in training increases, or the motivation decreases. The motivation icon 403 indicates motivation, which is a parameter indicating the conditions of the character being raised. In this embodiment, the motivation is set in terms of five levels, namely, terrible, poor, normal, good, and excellent. The motivation parameter influences the merit of training and performance parameter at the time of participation in a race. In the case of terrible or poor, decreasing correction is applied to the merit of training and performance parameters at the time of race participation compared with the case of normal. In the case of good or excellent, increasing correction is applied to the merit of training and performance parameters at the time of race participation compared with the case of normal.

Furthermore, in the raising home screen, a rest button 404, a training button 405, a skill button 406, an infirmary button 407, a going-out button 408, and a race button 409 are provided as buttons for selecting various kinds of actions, such as training. In this embodiment, it is possible to issue an instruction for one kind of action (specifically, one kind among rest, training, infirmary, going out, and race) per turn. Upon completion of processing for an action in response to the instruction issued in the current turn, it is considered that the current turn has been consumed, and raising proceeds to the next turn. Note that, in this embodiment, as an exception, skill acquisition does not involve consuming a turn. In this embodiment, as already mentioned, five kinds of actions, namely, rest, training, infirmary, going out, and race, are set as actions for which a turn is consumed with the raising function, and there are cases where these kinds of actions are referred to as turn consuming actions as needed.

The rest button 404 is a button for issuing a rest instruction for recovering physical energy. When a tap input on the rest button 404 has been performed, a rest confirmation dialog box for confirming the instruction for rest is displayed. Then, when a tap input on an OK button has been performed in the rest confirmation dialog box, a rest result request is transmitted to the server 20. Upon receiving the rest result request, the server 20 performs computation concerning the amount of physical energy recovered, whether or not a game event is to occur, etc. and transmits a rest result response including the results of the computation to the player terminal 40. Upon receiving the rest result response, the player terminal 40 displays an animation indicating recovery of the physical energy gauge 402 on the basis of the computation results included in the rest result response and executes processing concerning a game event in the case where a game event is to occur.

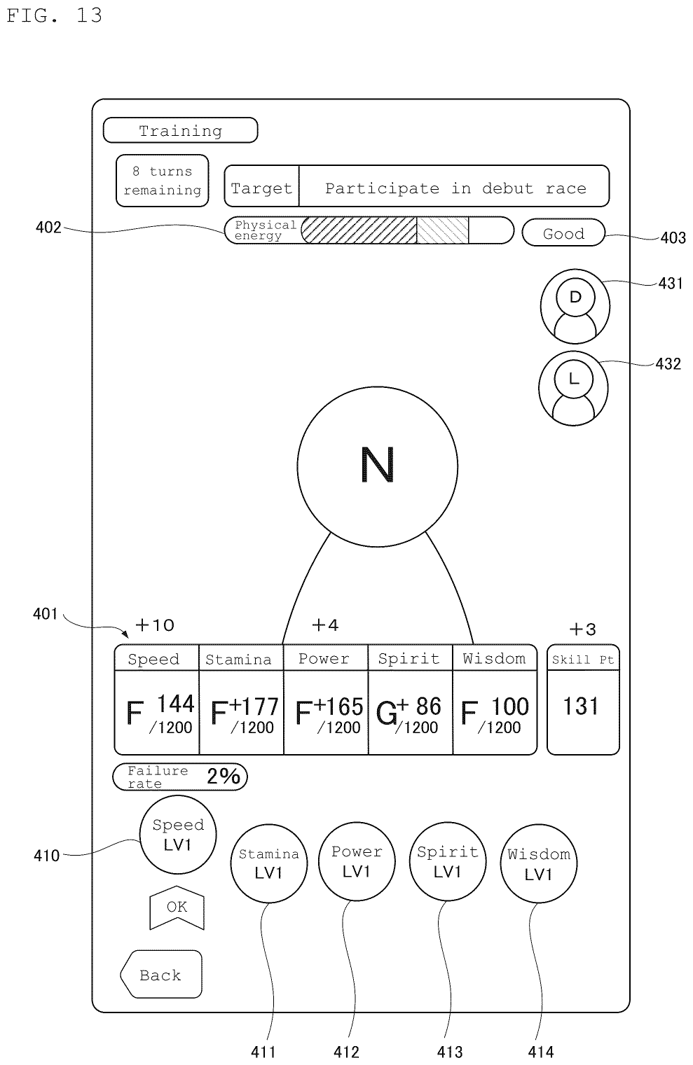

The training button 405 is a button for issuing a training instruction for changing a performance parameter of the character. When a tap input on the training button 405 has been performed, the display screen changes to a training screen, as shown in FIG. 13.

In the training screen, a speed button 410, a stamina button 411, a power button 412, a spirit button 413, and a wisdom button 414 are disposed in the region where various kinds of buttons are disposed in the raising home screen. In this embodiment, for convenience of explanation, there are cases where buttons for issuing instructions for individual kinds of training are collectively referred to as training buttons.

The training screen is arranged such that a training instruction is issued by performing a tap input on a training button in the selected state. It is possible to change the training button in the selected state by performing a tap input to a training button that is different from the training button in the selected state.

In the training screen, it is indicated which performance parameter is increased by what amount and what amount of skill points can be acquired with a training instruction via the training button in the selected state. In the example shown in FIG. 13, the speed button 410 is in the selected state, and it is understood that in the case where speed training is instructed, the speed is increased by 10, the power is increased by 4, and 3 skill points can be acquired. In this embodiment, the speed and the power are increased in the case where speed training is performed, the stamina and the spirit are increased in the case where stamina training is performed, the power and the stamina are increased in the case where power training is performed, the spirit, the power, and the speed are increased in the case where spirit training is performed, and the wisdom and the speed are increased in the case where wisdom training is performed. It is possible to acquire skill points in the case where any kind of training is performed.

In this embodiment, one of the support items incorporated before the start of raising is randomly associated with training through a lottery by the server 20 in each turn. With the training item with which a support item is associated, the amount of increase in a performance parameter or the amount of skill points acquired through training is increased due to the merit of the support item. In the example shown in FIG. 13, a character icon 431 representing a character D and a character icon 432 representing a character L are displayed in the state where the speed training item is selected. It is understood that the support item associated with the character D and the support item associated with the character L are assigned to the speed training item.

The physical energy is consumed in the case where training has been performed. The amount of physical energy consumed through training can be recognized in advance with the physical energy gauge 402 in the training screen. The physical energy is a parameter that influences the failure rate in training, and the failure rate tends to become higher as the physical energy decreases. In this embodiment, in the case where a training instruction has been issued, the server 20 performs a lottery based on the failure rate to determine whether or not the training fails. In the case where the training does not fail (in the case where the training is successful), the result is an increase in the performance parameter corresponding to the training instruction. In the case where the training fails, the performance parameter is not increased, and the physical energy is consumed.

When a tap input on the training button in the selected state has been performed in the training screen, a training result request is transmitted to the server 20. Upon receiving the training result request, the server 20 performs computation concerning the result of the training, whether or not a game event is to occur, etc. and transmits, to the player terminal 40, a training result response including the results of the computation. Upon receiving the training result response, the player terminal 40 performs display processing concerning the training result on the basis of the computation results included in the training result response (displaying concerning the success/failure of training and displaying changes in performance parameters) and executes processing concerning a game event in the case where a game event is to occur.

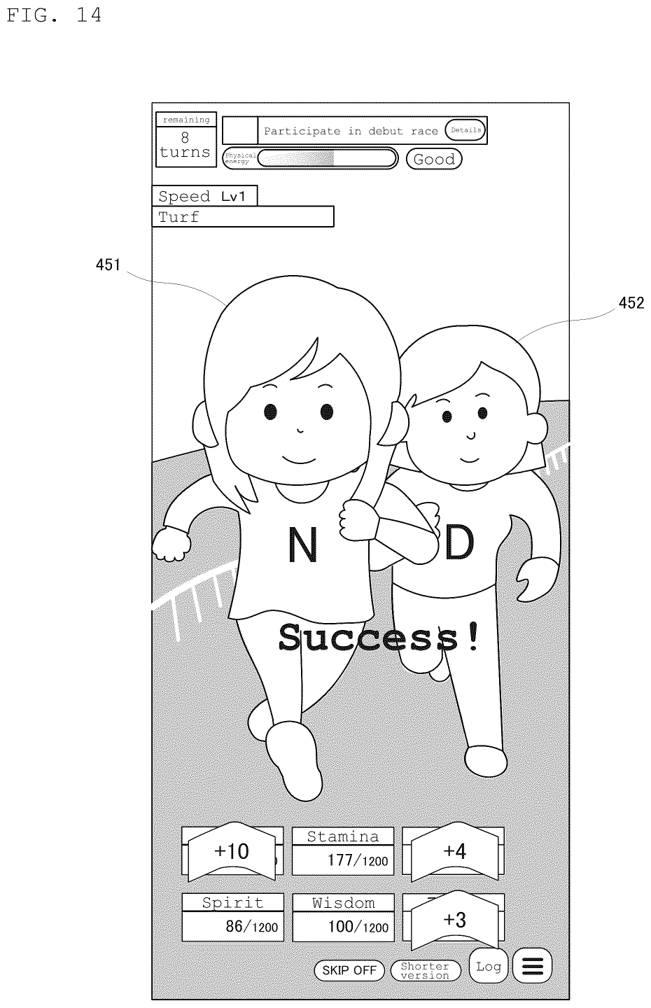

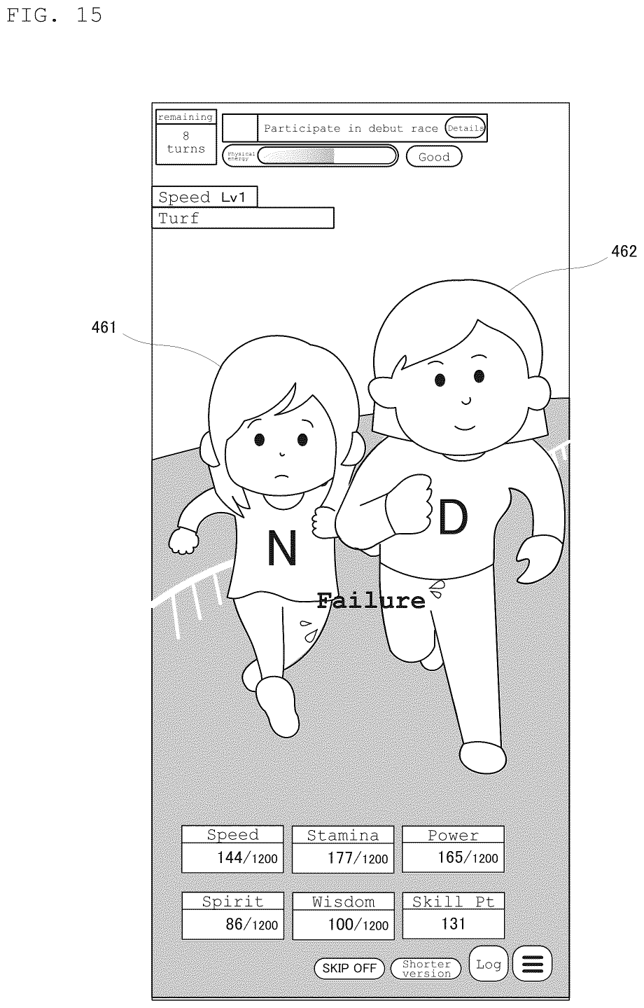

As an example, in the case where the training instructed to the raising subject character is successful, game rendition corresponding to the success of the training is executed, as shown in FIG. 14. In the example shown in FIG. 14, game rendition is executed such that training in which a raising subject character 451 (character N) and a training partner character 452 (character D) run side by side is conducted and such that the raising subject character 451 (character N) finishes ahead of the training partner character 452 (character D). As another example, in the case where the training instructed to the raising subject character fails, game rendition corresponding to the failure of the training is executed, as shown in FIG. 15. In the example shown in FIG. 15, game rendition is executed such that training in which a raising subject character 461 (character N) and a training partner character 462 (character D) run side by side is conducted and such that the training partner character 462 (character D) finishes ahead of the raising subject character 461 (character N). As described above, in this embodiment, there are cases where different kinds of game rendition are executed depending on the result of training.

The training partner that appears in game rendition is a character corresponding to the support item assigned to the training instructed by the player. In the case where a plurality of support items are assigned, it is possible to randomly determine the training partner from among the plurality of support items assigned to the training instructed by the player. The arrangement may be such that in the case where a plurality of support items are assigned, the training partner is determined according to a predetermined condition (e.g., a support item for speed is prioritized for speed training) instead of being determined randomly. Meanwhile, in the case where no support item is assigned to the training instructed by the player, game rendition is executed such that there is no training partner and such that only the raising subject character appears. Note that the arrangement may be such that even in the case where no support item is assigned to the training instructed by the player, a support item is randomly determined from among the support items incorporated by the player before the start of raising, which makes it possible to determine the character corresponding to the support item determined as the training partner.

Furthermore, in this embodiment, each character has prepared therefor base body data, costume data, motion data, etc. As for the costume data and the motion data, a plurality of kinds are prepared in accordance with scenes of game rendition that is executed. As for background data concerning game rendition as well, a plurality of kinds are prepared in accordance with scenes of game rendition. Data of rendition materials for executing these kinds of game rendition are stored in the raising-progress-data storage unit 72. In the display processing concerning the training result, a rendition execution pattern is determined on the basis of individual items of information indicating the kind of training, the training level, the success/failure of training, the season, the place of training, and the training partner, the base body data, the costume data, and the motion data of the raising subject character (e.g., the character N) and the training partner character (e.g., the character D) are set, character images of actions of the raising subject character (e.g., the character N) and character images of actions of the training partner character (e.g., the character D) are generated, and the background data is set on the basis of the determined rendition execution pattern to generate a background image. Then, the individual character images are combined with the background image to generate images of individual frames from the first frame to the last frame of game rendition, and the images are output to the display unit 44.

The skill button 406 is a button for letting the character acquire a skill. When a tap input on the skill button 406 has been performed, a skill acquisition screen showing a list of skills that can be acquired by the character at that timing is displayed. When a skill has been selected and a tap input on an acquisition button has been performed in the skill acquisition screen, a skill acquisition request is transmitted to the server 20. Upon receiving the skill acquisition request, the server 20 registers the skill specified in the skill acquisition request as an acquired skill in the status information of the character being raised and transmits a skill-acquisition completion response to the player terminal 40. Upon receiving the skill-acquisition completion response, the player terminal 40 displays a message to the effect that a skill has been acquired and executes processing for displaying the skill acquired as an acquired skill in the skill acquisition screen.

The infirmary button 407 is a button used to resolve a bad status assigned to the character being raised, and an input is accepted only in the case where a bad status has been assigned through a game event during raising. In this embodiment, there are cases where a bad status, such as a lack of sleep, is assigned due to the occurrence of a game event. When such a bad status has been assigned, it becomes more likely that a game event disadvantageous for raising occurs: for example, it becomes more likely that the physical energy decreases; or it becomes more likely that the motivation decreases. In the case where a bad status has not been assigned to the character being raised, the infirmary button 407 is displayed in a grayed-out manner. In the case where a bad status has been assigned to the character being raised, the infirmary button 407 is displayed normally to accept a tap input. In the case where an instruction for resolving the bad status via the infirmary button 407 has been issued, an infirmary result request is transmitted to the server 20. Upon receiving the infirmary result request, the server 20 performs a lottery to determine whether or not the bad status has been resolved and transmits an infirmary result response including the result determined to the player terminal 40. Upon receiving the infirmary result response, in the case where the bad status is resolved, the player terminal 40 issues a notification that the bad status has been resolved and performs processing for erasing the bad status from the displayed status of the character.

The going-out button 408 is used to increase the motivation of the character being raised. When a tap input on the going-out button 408 has been performed, a going-out confirmation dialog box for confirming the instruction for going out is displayed. Then, when a tap input on an OK button has been performed in the going-out confirmation dialog box, a going-out result request is transmitted to the server 20. Upon receiving the going-out result request, the server 20 performs a lottery concerning a motivation increasing event and transmits a going-out result response to the player terminal 40, the going-out result response including motivation increasing event information determined through the lottery. Upon receiving the going-out result response, the player terminal 40 executes processing concerning the motivation increasing event on the basis of the information included in the going-out result response. Furthermore, in the case where going out is specified as an action of the raising subject character, the destination of going out concerning the motivation increasing event is randomly determined through a lottery, and game rendition is executed in accordance with a rendition execution pattern based on the destination determined through the lottery and the season corresponding to the turn in which going out is specified.

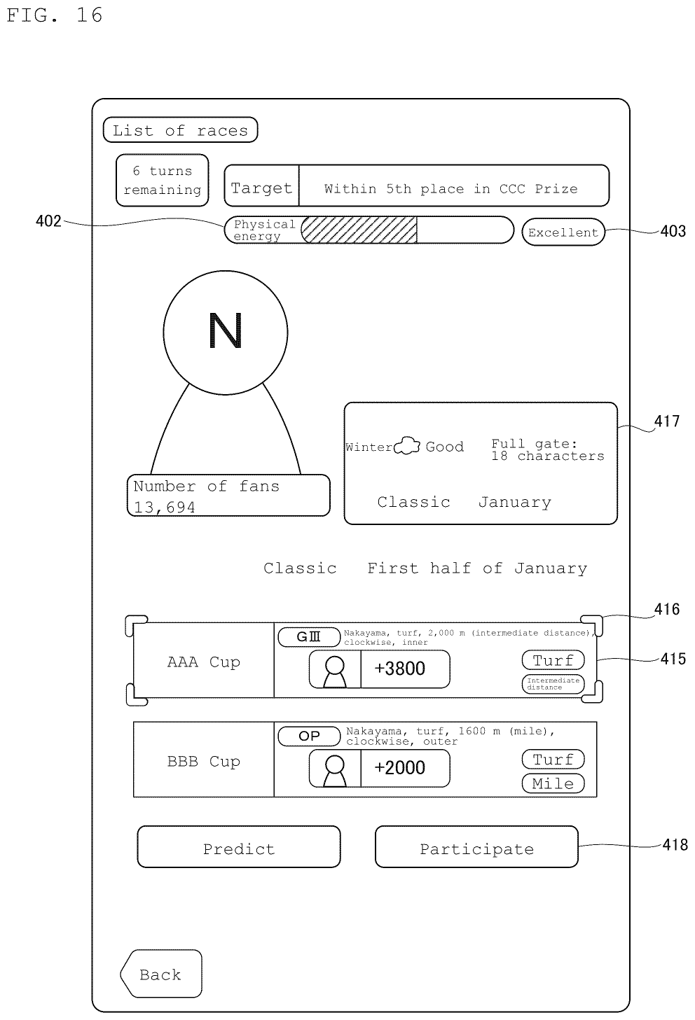

The race button 409 is a button used to let the character being raised participate in a race. When a tap input on the race button 409 has been performed, the display screen changes to a race list screen showing a list of races held in the current turn, as shown in FIG. 16.

In the race list screen, it is possible to select a race in which the character being raised participates by performing a tap input on a race selection box 415. It is possible to distinguish the race currently selected on the basis of the presence or absence of a selection mark 416. In a race-condition display area 417, race condition information concerning the race currently selected is displayed, such as the season (spring, summer, autumn, or winter), the weather (sunny, cloudy, rainy, or snowy), course conditions (good, slightly heavy, heavy, or poor), the number of participating characters, and the turn in which the race is held. When the race currently selected is changed, the content displayed in the race-condition display area 417 is also changed in accordance with the race currently selected. Furthermore, each race has specified therefor a participating condition based on the status of the number of fans acquired by the character being raised. As for races for which the character being raised does not satisfy the participating condition, the race selection boxes 415 are displayed in a grayed-out manner, prohibiting participation.

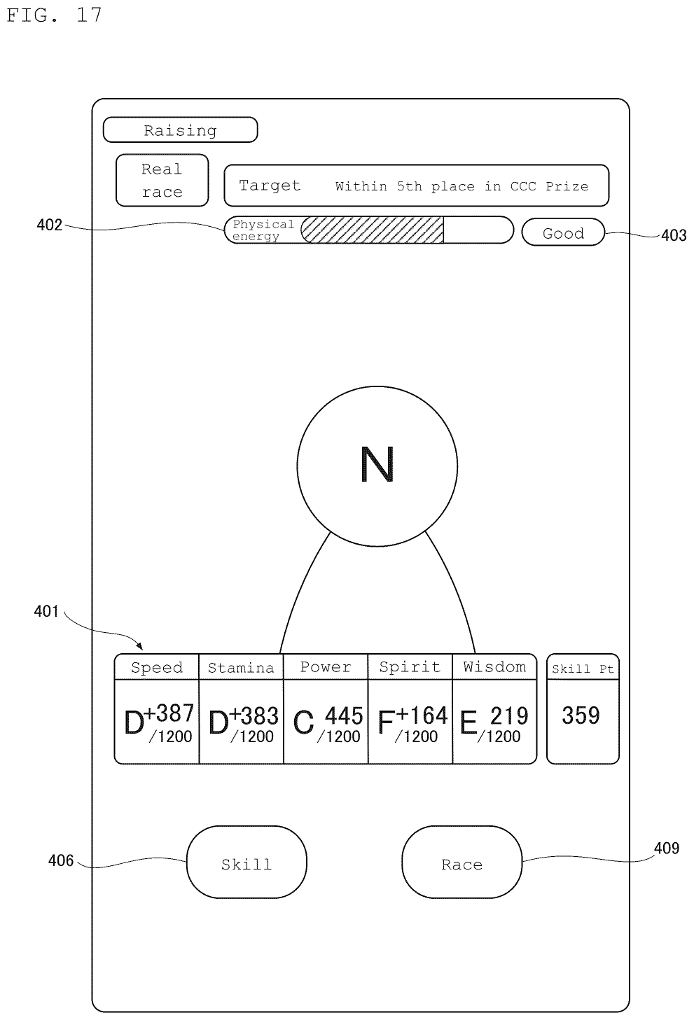

Furthermore, in this embodiment, there are cases where a target race is set as the raising target. In a turn in which a target race is set, the raising home screen is displayed in a different manner, and only the skill button 406 and the race button 409 are displayed as buttons for selecting an action, as shown in FIG. 17. That is, in a turn in which a target race is set, it is possible only to participate in a race as a turn consuming action.

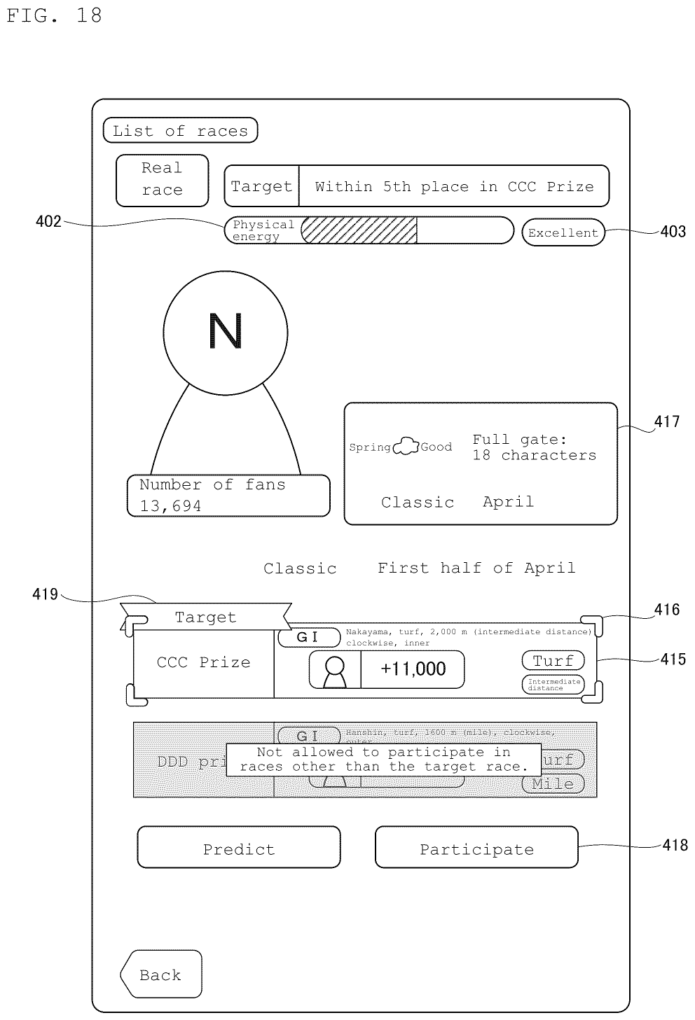

FIG. 18 is an illustration showing an example race list screen in a turn in which a target race is set. In the case where a target race is set as the raising target, control is performed such that it is possible to select only the target race in the race list screen. In this embodiment, in a race list screen including a target race, a target badge 416 is attached to the race selection box 415 for the target race, which makes it possible to distinguish the target race. As for races other than the target race, the race selection boxes 415 are displayed in a grayed-out manner, prohibiting participation.

When a tap input on a participation button 418 has been performed in the state where the selection box 415 for the race to participate in is selected in the race list screen, a participation request is transmitted to the server 20. Upon receiving the participation request, the server 20 performs a simulation of the character being raised and NPCs (non-player characters) running in a race to participate in and transmits a race result response including the result of the running simulation to the player terminal 40. Upon receiving the race result response, the player terminal 40 executes display processing for letting the player view how the race went on the basis of the result of the running simulation.

In this embodiment, in the case of letting the character being raised participate in a race, performance parameters are adjusted in accordance with the level of motivation in the turn in which participation is instructed. In the case where the motivation is terrible or poor, decreasing correction is applied to performance parameters compared with the case where the motivation is normal. In the case where the motivation is good or excellent, increasing correction is applied to performance parameters compared with the case where the motivation is normal.

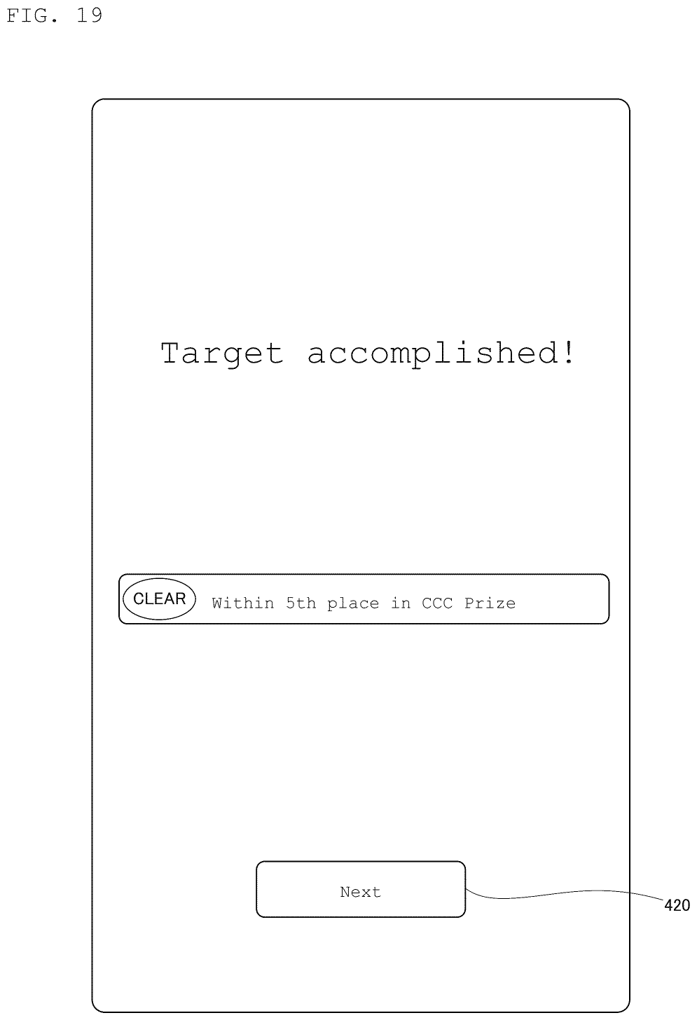

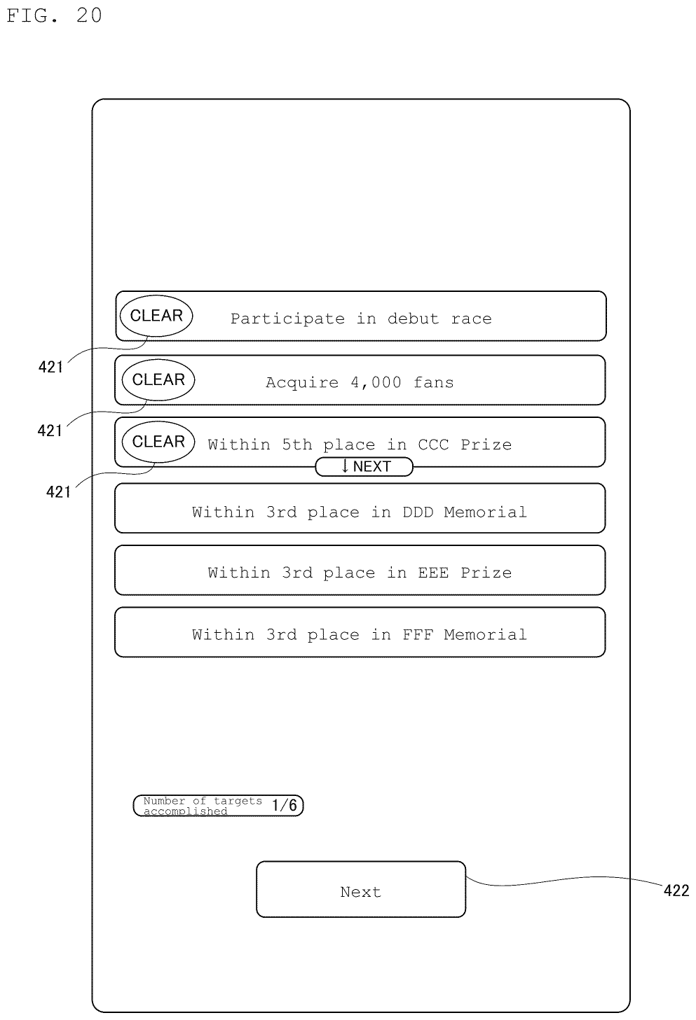

In a turn in which a raising target is set in raising a character, it is determined whether or not the raising target has been accomplished. In the case where the raising target has been accomplished, a target-accomplishment notification screen is displayed, as shown in FIG. 17. In an example shown in FIG. 19, the raising target is winning a result within the 5th place in “CCC Prize”, which is the target race. In the case where the character being raised succeeds in winning a result within the 5th place in “CCC Prize”, the result of the target race is displayed, and then the target-accomplishment notification screen is displayed. A next button 420 is provided in the target-accomplishment notification screen, and when a tap input on the next button 420 has been performed, the display screen changes to a target list screen, as shown in FIG. 20.

In the target list screen, a list of raising targets set for the character being raised is displayed in order of the progress of turns. In an example shown in FIG. 20, six raising targets are set for the character being raised, and a clear mark 421 indicating the accomplishment of the raising target is attached to each of the raising targets up to the third raising target “within 5th place in CCC Prize”. A next button 422 is provided in the target list screen, and when a tap input on the next button 422 has been performed, raising proceeds to the next turn, and the display screen returns to the raising home screen.

In this embodiment, individual raising targets are set in the period up to the 72nd turn, and the number of raising targets and the content of the raising targets are set individually in accordance with the kind of the character. Furthermore, when all the raising targets have been accomplished for the character being raised, it becomes possible to advance to the closing races in and after the 73rd turn.

In the case where all the raising targets have been accomplished in raising a character, in and after the 73rd turn, first, the character participates in the qualifying race. If the character wins the 1st place as the result of the qualifying race, the character participates in the semifinal race. If the character wins the 1st place as the result of semifinal race, the character participates in the final race. If the character wins the 1st place as the result of the final race, the character becomes the champion of the closing races, and raising is finished. It is also possible to issue a raising instruction before participation in each of the turns for the qualifying race, the semifinal race, and the final race. The closing races in and after the 73rd turn are extra turns, in which raising targets are not set. In the case where the qualifying race or the semifinal race ends up in a result other than the 1st place, rechallenge is possible by using the continuation function; however, raising is finished in the case where the number of continuations is not remaining. As mentioned earlier, the use of the continuation function is up to selection by the player. Thus, even in a situation where it is possible to use the continuation function, in the case where the player selects not to use the continuation function, it is considered that the character is defeated in the closing races, and raising is finished.

Meanwhile, in the case of a failure to accomplish a raising target set for the character being raised, raising is finished at that timing. In particular, in this embodiment, in the case where the raising target is winning a result within a prescribed place in a target race, even if the character fails to win a result within the prescribed place in the target race, rechallenge is possible by using the continuation function. However, in the case where the raising target is acquiring a prescribed number of fans by a prescribed turn and in the case where the raising target is participation in a target race, in the case of a failure to accomplish the raising target, it is not possible to use the continuation function, and raising is finished at the timing of a turn for checking the raising target.

Then, when the condition for finishing raising is satisfied in the raising progress processing (Y in step S106), finish confirmation processing is performed (step S107). In the finish confirmation processing, a finish confirmation screen that makes it possible to confirm the statuses of the raising subject character is displayed. A skill acquisition button and a raising finish button are provided in the finish confirmation screen. When a tap input on the skill acquisition button has been performed, a list of skills that can be acquired is displayed, which makes it possible to acquire skills within the range of skill points possessed. When a tap input on the raising finish button has been performed, raising finish processing is performed (step S108).

First, in the raising finish processing, the raised character is registered. The registration of the raised character is completed by calculating an evaluation score and determining factor information to fix the statuses of the character and saving the statuses in the character list in the player-data storage unit 71 in association with the character individual ID. The evaluation score is calculated on the basis of the performance parameters and acquired skills of the character, and factor information is determined through lotteries.

In particular, factor information is determined with reference to the content of raising of the character (race participation history, etc.) and the statuses (performance parameters, acquired skills, etc.) at the timing of completion of raising. Furthermore, of the factor information, blue factors and red factors are necessarily assigned, and unique factors are assigned in the case where the talent development level (level 1 to level 5) of the raising subject character is higher than or equal to a prescribed level (higher than or equal to level 3). Furthermore, of the factor information, as for white factors, skill factors are determined with reference to the acquired skills, race factors are determined with reference to races in which the character participated during raising and that the character won, and scenario factors are determined with reference to the raising scenario selected before the start of raising. Furthermore, in the case where factor information is assigned, the factor level of the factor information determined to be assigned is also determined through a lottery. In this embodiment, the factor level is randomly set to one of three levels from level 1 to level 3.

Furthermore, in the raising finish processing, a reward for the result of raising is also provided. In this embodiment, the reward is provided by being added to the item list in the player-data storage unit 71. An amount of the in-game currency and support points corresponding to the number of fans acquired during raising are determined as the reward, and it is possible to acquire greater amounts of the in-game-currency and support points as the number of fans becomes greater.

Furthermore, in the raising finish processing, a raising finish request is transmitted to the server 20. Upon receiving the raising finish request, the server 20 registers the raised character in the character list in the player management database 51 and adds the reward for the result of raising to the item list in the player management database 51.

As described above, with the raising function provided in the information processing system 10 in this embodiment, game rendition corresponding to the result of an action occurs as a result of performing a turn consuming action in the process of raising a character, such as issuing a training instruction or issuing a going-out instruction. With these kinds of game rendition, it is not rare that different kinds of game rendition occur due to branching of the results of actions (e.g., the success/failure of training) even if the same action is instructed to the raising subject character. Furthermore, with game rendition that occurs correspondingly to the result of an action by the character in the raising process, characters that appear in the game rendition are composed with the raising subject character as a main element and the character of a support item assigned to the instructed training as a sub-element. Thus, a random factor is involved in determining the character that appears as a sub-element, and a huge playing time is required in order to cover all the rendition execution patterns.

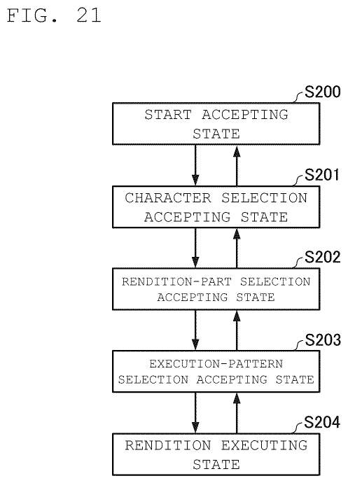

Therefore, in this embodiment, the rendition viewing function is provided, which makes it possible for the player to view game rendition of desired content by customizing characters and rendition execution patterns. The following describes in more detail game progress with the rendition viewing function, which makes it possible to arbitrarily view game rendition that may be executed with the raising function, with reference to example state transitions shown in FIG. 21.

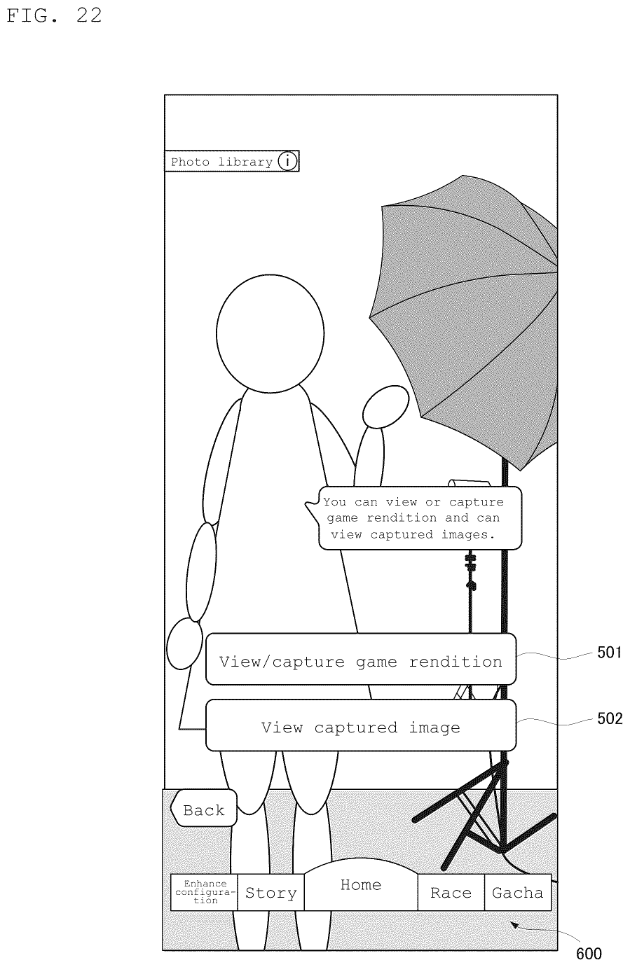

First, the state is set to a use-start accepting state for accepting the start of use of the rendition viewing function (step S200). In this embodiment, the rendition viewing function is provided as a part of game functions referred to as a photo library, and the start of use of the rendition viewing function is accepted via a photo-library top screen shown in FIG. 22.

Two kinds of use start buttons 501 and 502 exist in the photo-library top screen. The use start button 501 is a button for starting the use of the rendition viewing function. The use start button 502 is a button for starting the use of a function for viewing a saved screenshot image.

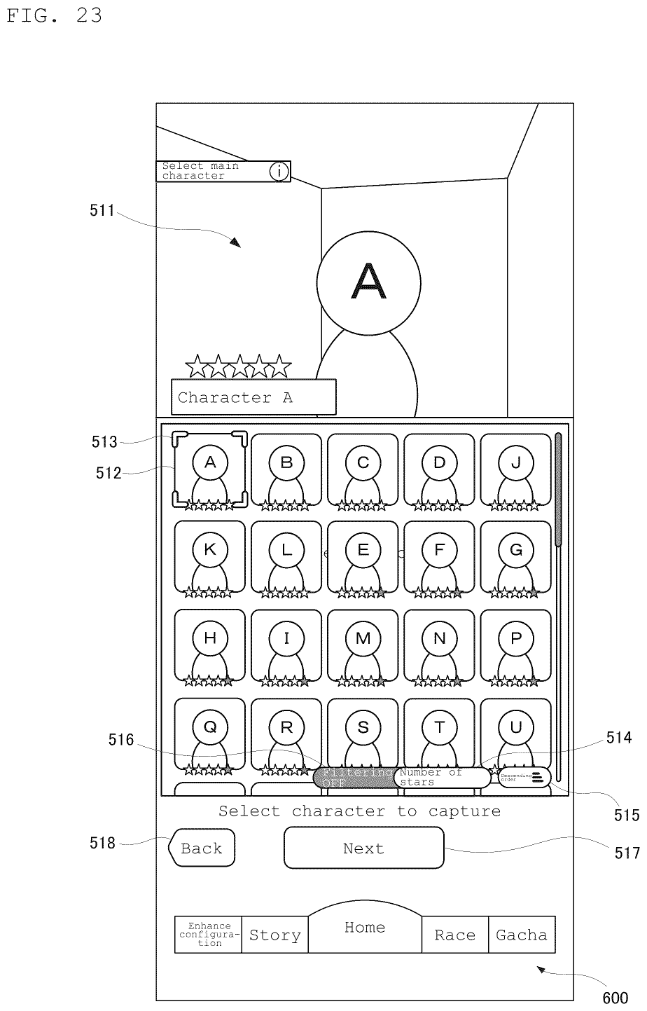

When a tap input has been performed on the use start button 501 in the state where the photo-library top screen is displayed (step S201), the use of the rendition viewing function is started, and the display screen changes to a character-selection accepting state (step S201). In the character-selection accepting state, selection of a character that appears in game rendition as a main element (main character) is accepted via a main-character selection screen. In the main-character selection screen, a list of released characters possessed by the player is displayed, as shown in FIG. 23. It is possible to select the main character from among the released characters possessed by the player. Characters not yet released are not presented as selectable candidates in the main-character selection screen, so that it is not possible to view game rendition in which a character not yet released appears as a main character. Alternatively, the arrangement may be such that it is possible to select a character not yet released as a main character with the rendition viewing function, which makes it possible to view game rendition in which a character not yet released appears as a main character.

In the main-character selection screen, a character currently selected is displayed in a currently-selected-character display area 511. It is possible to select a character by performing a tap input on a character icon 512, and a selection mark 513 is attached to the character icon 512 of the currently selected character.

Furthermore, in the main-character selection screen, concerning the displaying of the list of released characters, it is possible to change the display mode through sorting and filtering. As the subject of sorting, it is possible to select items such as the number of stars (rarity), the level of affection, the order of acquisition, and the name, and it is possible to switch between ascending order and descending order for each item. In the main-character selection screen, a sort change button 514 is provided, and it is possible to change the subject of sorting by performing a tap input on the sort change button 514. Furthermore, in the main-character selection screen, an ascending/descending order change button 515 is provided, and it is possible to perform switching from ascending order to descending order and switching from descending order to ascending order by performing a tap input on the ascending/descending change button 515. As the subject of filtering, it is possible to specify rarity (the number of stars). When the filtering function is enabled by performing a tap input on a filtering button 516, it is possible to change the display mode such that only characters having the specified rarity are displayed. When a tap input on the filtering button 516 has been performed in the state where the filtering function is enabled, the filtering function becomes disabled, and the display mode is changed such that all the released characters are displayed.

In this embodiment, information indicating character selection in the main-character selection screen when the rendition viewing function is used is saved in the player-data storage unit 71. In the next occasion of transition to the main-character selection screen, an initially selected character is determined on the basis of the saved main-character selection information. On the occasion of initial transition to the main-character selection screen, the character having the highest sort order (the character displayed at the leftmost position on the uppermost row in the display screen) among the released characters is considered as an initially selected character.

Furthermore, in the main-character selection screen, a next button 517 and a back button 518 are provided. When a tap input on the next button 517 has been performed, the currently selected character is set as a main character, and the state changes to a rendition-part selection accepting state (step S202). Meanwhile, when a tap input on the back button 518 has been performed, the state returns to the start accepting state (step S200), and the display screen changes to the photo-library top screen.

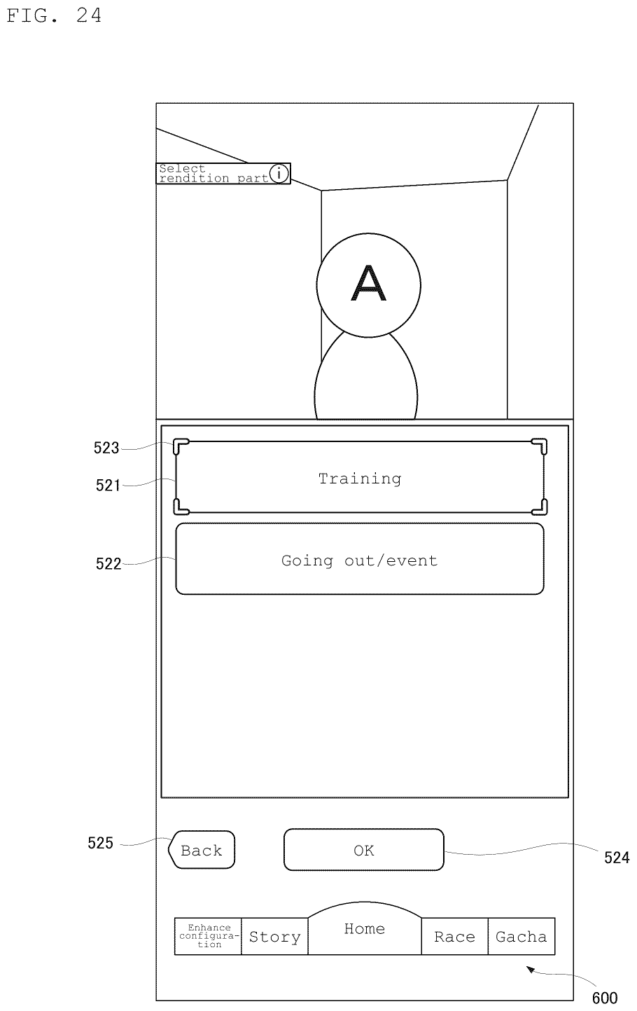

In the rendition-part selection accepting state, selection of a rendition part associated with the content of an action of the character in a rendition execution pattern is accepted via a rendition-part selection screen shown in FIG. 24. In this embodiment, two kinds of selection candidates are prepared, of which one is a rendition part corresponding to training and the other is a rendition part corresponding to going out and events (going out, special events, etc.). Selection for each rendition part is performed by using a training selection button 521 and a going-out/event selection button 522. When a tap input on one of these buttons has been performed, a selection mark 523 is attached to the button corresponding to the currently selected rendition part. Note that on the occasion of a transition to the rendition-part selection screen, the initially selected rendition part is set to training.

Furthermore, in this embodiment, the kinds of game rendition that can be viewed with the rendition viewing function are classified into game rendition that occurs in response to a training instruction with the raising function, and game rendition that occurs in response to an instruction other than a training instruction as well as game rendition corresponding to an event that may occur randomly in the raising process. The former can be selected by using a training selection button 521 as a rendition part corresponding to training, and the latter can be selected by using a going-out/event selection button 522 as a rendition part corresponding to going out and events. Furthermore, in this embodiment, because game rendition that occurs in response to a training instruction with the raising function is executed on the basis of many conditions in the process of raising a character, branching is provided between game rendition that occurs in response to a training instruction and other rendition so that more detailed scenes can be specified.

Furthermore, in the rendition-part selection screen, an OK button 524 and a back button 525 are provided. When a tap input on the OK button 524 has been performed, the state changes to an execution-pattern selection accepting state, in which more specific conditions for the rendition execution pattern are set for the selected rendition part (step S203). Meanwhile, when a tap input has been performed on the back button 525 in the situation where the rendition-part selection screen is displayed, the state returns to the character-selection accepting state (step S201), and the display screen changes to the main-character selection screen.

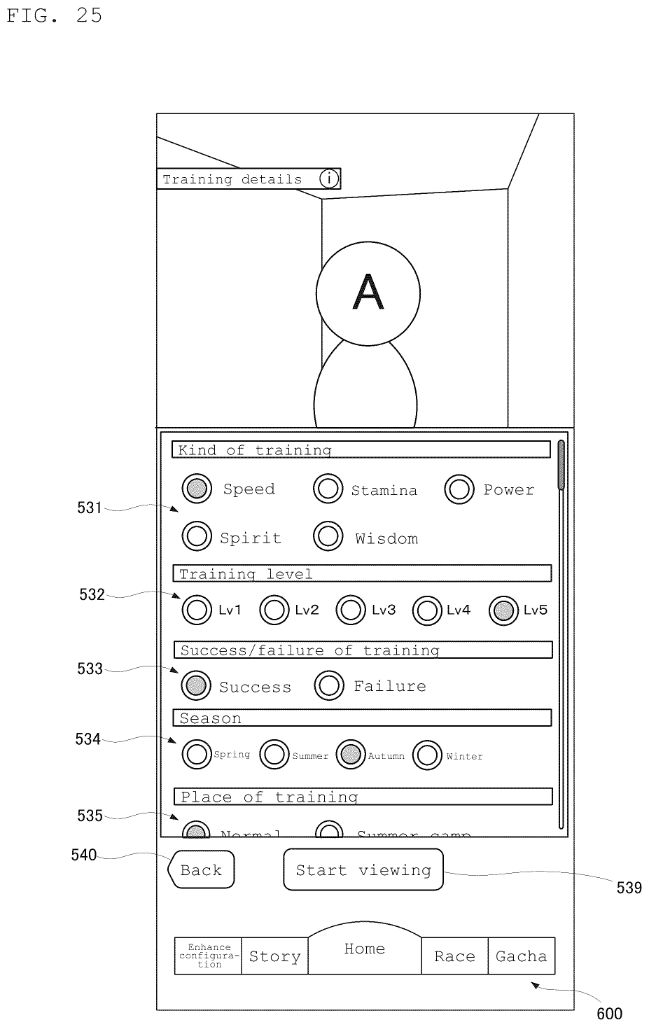

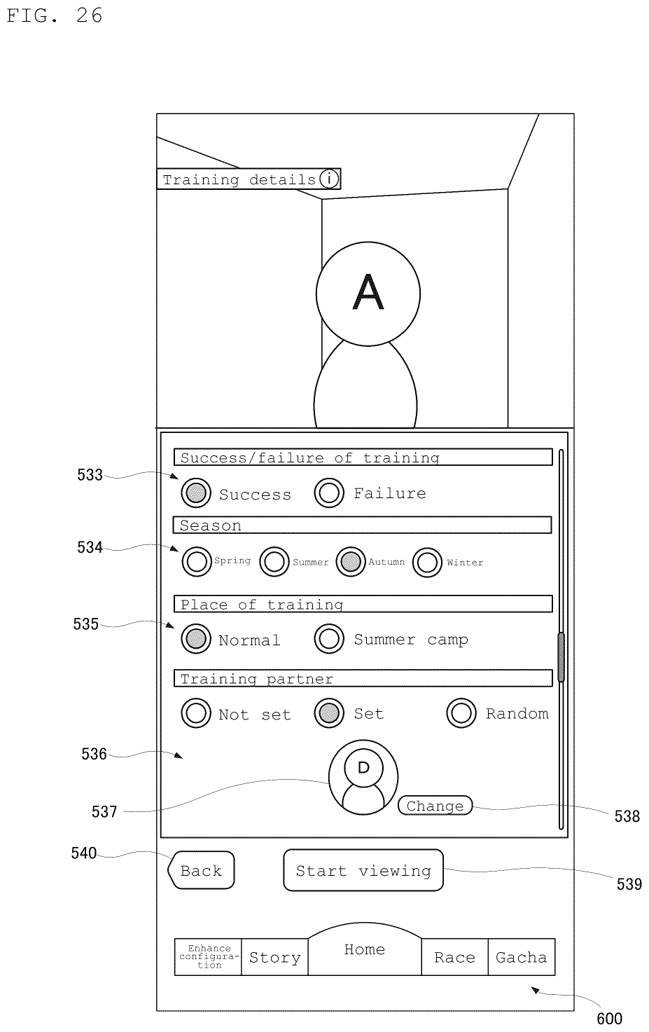

For example, in the case where training is selected, a training-detail selection screen is displayed, as shown in FIGS. 25 and 26. As for game rendition corresponding to training, it is possible to customize settings for individual items of the kind of training, the training level, the success/failure of training, the season, the place of training, and the training partner. Furthermore, in the training-detail selection screen, the following display areas are provided: a first display area 531, in which selection candidates concerning the kind of training are presented; a second display area 532, in which selection candidates concerning the training level are presented; a third display area 533, in which selection candidates concerning the success/failure of training are presented; a fourth display area 534, in which selection candidates concerning the season are presented; a fifth display area 535, in which selection candidates concerning the place of training are presented; and a sixth display area 536, in which selection candidates concerning training partner are presented. In this embodiment, in the training-detail selection screen, radio buttons individually corresponding to a plurality of selection candidates are provided for each of the kind of training, the training level, the success/failure of training, the season, the place of training, and the training partner. When a tap input on one of the radio buttons has been performed, only the radio button on which the tap input has been performed is displayed as enabled among the radio buttons for the same item, which makes it possible to specify one selection candidate for each item. For example, in the situation shown in FIG. 25, as for the item of the kind of training, the radio button corresponding to “speed” is displayed as enabled, and the radio buttons corresponding to “stamina”, “power”, “spirit”, and “wisdom” are displayed as disabled, which means that “speed” is specified.

The kinds of training presented in the first display area 531 include “speed”, “stamina”, “power”, “spirit”, and “wisdom”, and it is possible to select one of these alternatives. The training levels presented in the second display area 532 include five levels, namely, “level 1” (Lv1), “level 2” (Lv2), “level 3” (Lv3), “level 4” (Lv4), and “level 5” (Lv5), and it is possible to select one of these alternatives. In this embodiment, in the case where the training level varies, the content of game rendition varies even if the kind of training is the same. As for the training level, there are cases where restrictions arise concerning selection in relation to the place of training, which will be described later. In this embodiment, a turn corresponding to “summer camp” is provided for the raising function. In the turn for “summer camp”, the training level is necessarily “level 5”. Thus, in the case where “summer camp” is selected as the place of training, only “level 5” is enabled, and “level 1” to “level 4” are displayed in a grayed-out manner, prohibiting selection thereof. As described above, in the training-detail selection screen, in the case where “summer camp” is selected as the place of training, accordingly, only a suitable selection candidate is enabled for the item of the training level. This serves to improve the convenience of input by the player. The success/failure of training, presented in the third display area 533, includes “success” and “failure”, and it is possible to select one of these alternatives. The season presented in the fourth display area 534 includes “spring”, “summer”, “autumn”, and “winter”, and it is possible to select one of these alternatives. In this embodiment, the costume of the character changes or the background changes in accordance with the season. Note that there are cases where restrictions arise also concerning selection of the season in relation to the place of training, which will be described later. Specifically, the arrangement is such that, in the case where “summer camp” is selected as the place of training, all the selection candidates concerning the season are disabled, prohibiting selection thereof. As described above, in the training-detail selection screen, in the case where “summer camp” is selected as the place of training, accordingly, restrictions arise also concerning selection of the item of the season. This serves to improve the convenience of input by the player. The place of training presented in the fifth display area 535 includes “normal” and “summer camp”, and it is possible to select one of these alternatives. In this embodiment, in the case where the place of training is “normal”, game rendition with a background corresponding to the season is executed. In the case where the place of training is “summer camp”, the background has a special design, and game rendition with a beach serving as the background is executed. Furthermore, as mentioned earlier, in the case where “summer camp” is selected as the place of training, restrictions arise concerning selection of the season and the training level.

The training partner presented in the sixth display area 536 includes “not set”, “set”, and “random”, and it is possible to select one of these alternatives. In the case where “set” is selected for the training partner, it is possible to select a character that serves as the training partner from within the support items possessed by the player.

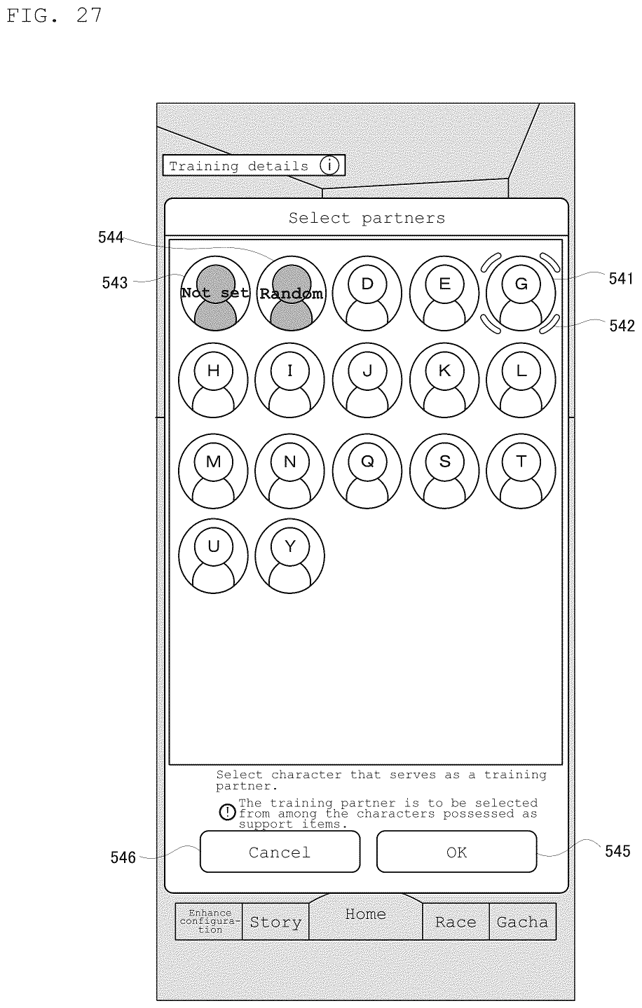

On the occasion of a transition to the training-detail selection screen, when the initial selection concerning the training partner is “not set” and a tap input on the radio button corresponding to “set” has been performed to select “set”, a partner selection dialog is displayed, as shown in FIG. 27, which makes it possible to select a character to be set as the training partner. Furthermore, in the case where the player wishes to change the training partner, it is possible to summon the partner selection dialog by performing a tap input on a change button 538 provided in the sixth display area 536 in the training-detail selection screen.

In this embodiment, one or two corresponding characters are set for each support item. Furthermore, there are cases where support items associated with the same character support different parameters in training, such as the speed support item of the character A and the power support item of the character A. Furthermore, there are three levels of rarity (R<SR<SSR) for support items, and the merit of support with the raising function tends to be higher as the rarity becomes higher. Furthermore, there are three categories of support items, namely, “normal”, “friend”, and “group”. Each support item classified as “normal” is a support item associated with one of the performance parameters, such as speed, and corresponding to a single character. Each support item classified as “friend” or “group” is a support item that is not associated with any specific performance parameter and that makes it possible to generate an item-specific going-out event with the raising function. Furthermore, “group” has two or more characters corresponding thereto and makes it possible to generate a going-out event with each character. The selection candidates of the training partner with the rendition viewing function are support items classified as “normal” and are not affected by the rarities of support items possessed by the player or the kinds of performance parameters supported. Alternatively, the selection candidates for the training partner may be presented in association with the kinds of performance parameters of support items.

Furthermore, in the partner selection dialog, a list of characters corresponding to the support items classified as “normal” among the support items possessed by the player is displayed by using character icons 541. In this embodiment, it is possible to select a training partner by performing a tap input on one of the character icons 541 displayed as a list in the situation where the partner selection dialog is displayed. For the currently selected character, a selection mark 542 is attached to the character icon 541, which makes it possible to recognize which character is selected. When a tap input on an OK button 545 has been performed in the state where the selection mark 542 is attached to one of the character icons 541, the character corresponding to the character icon 541 having the selection mark 542 attached thereto is set as the training partner, which is reflected to the character icon 537 in the training-detail selection screen. When a tap input on a cancel button 546 provided in the partner selection dialog has been performed, the content of current selection is discarded, the partner selection dialog is closed, and the display screen returns to the training-detail selection screen.

Furthermore, a not-set icon 543 and a random icon 544 are provided in the partner selection dialog. When a tap input on the OK button 545 has been performed in the state where one of these icons is selected, the selection is reflected as the content selected for the item of the training partner. As an example, when a tap input on the OK button 545 has been performed in the state where the not-set icon 543 is selected, the radio button for “not set” becomes enabled for the item of the training partner in the training-detail selection screen. As another example, when a tap input on the OK button 545 has been performed in the state where the random icon 544 is selected, the radio button for “random” becomes enabled for the item of the training partner in the training-detail selection screen. As described above, in this embodiment, it is allowed to select any of “not set”, “set”, and “random” for the item of the training partner in the partner selection dialog, which serves to improve the convenience of input.

Furthermore, this embodiment may be arranged such that the training partner is determined randomly instead of letting the player select the training partner. The arrangement may be such that, by selecting “random” for the item of the training partner, the training partner that appears in game rendition is randomly set through a lottery. In the case where “random” is selected for the item of the training partner, the subjects of the lottery are set within the support items possessed by the player, and one character is extracted randomly and is set as the training partner.

The arrangement may be such that not just one but two or more characters may be selected as training partners. Furthermore, control may be performed such that, with the setting “random”, the number of characters extracted is also determined randomly. Note that in the case where it is allowed to set two or more training partners, it is possible to provide an upper limit for the number of training partners that can be selected. Furthermore, the arrangement may be such that, with the setting “random”, the player is allowed to set the range of subjects of the lottery for the training partner.

Furthermore, a viewing start button 539 and a back button 540 are provided in the training-detail selection screen. When a tap input has been performed on the viewing start button 539, the state changes to a rendition executing state, in which game rendition is executed on the basis of the content of selection by the player in each of the character selection accepting state, the rendition-part selection accepting state, and the execution-pattern selection accepting state (step S204). When a tap input on the back button 540 has been performed in the situation where the training-detail selection screen is displayed, the state returns to the rendition-part selection accepting state (step S203), and the display screen changes to the rendition-part selection screen.

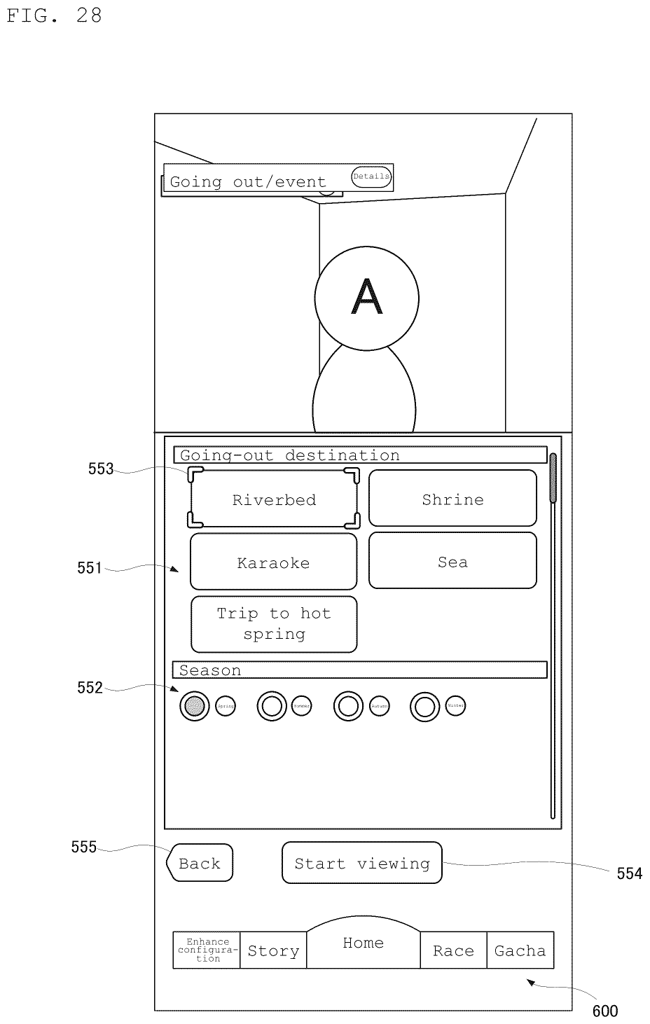

Meanwhile, for example, in the case where going out/event is selected, a going-out/event-detail selection screen shown in FIG. 28 is displayed. In this embodiment, it is possible to customize the setting for each of the items of the going-out destination and the season concerning the game rendition corresponding to going out/event. Furthermore, in the going-out/event-detail selection screen, a seventh display area 553, in which selection candidates concerning the going-out destination are presented, and an eighth display area 552, in which selection candidates concerning the season are presented, are provided. In this embodiment, in the going-out/event-detail selection screen, icons individually corresponding to a plurality of selection candidates are provided for the item of the going-out destination. By performing a tap input on one of the icons, a selection mark 553 is attached to the icon currently selected, which makes it possible to specify one of the selection candidates. Furthermore, in this embodiment, radio buttons individually corresponding to a plurality of selection candidates are provided for the item of the season in the going-out/event-detail selection screen. By performing a tap input on one of the radio buttons, only the radio button on which the tap input has been performed within the same item is displayed as enabled, which makes it possible to specify one of the selection candidates.

The going-out destination presented in the seventh display area 551 includes “riverbed”, “shrine”, “karaoke”, “sea”, and “trip to hot spring”, and it is possible to select one of these alternatives. Furthermore, the season presented in the eighth display area 552 includes “spring”, “summer”, “autumn”, and “winter”, and it is possible to select one of these alternatives. Note that in the case where “sea” is selected as the going-out destination, it is possible to select only “summer” for the season. Then, the radio button corresponding to “summer” is displayed as enabled, and the radio buttons for “spring”, “autumn”, and “winter” are displayed in a grayed-out manner, prohibiting selection thereof. As described above, in the going-out/event-detail selection screen, a radio button concerning the item of the season is automatically selected suitably in accordance with the going-out destination selected by the player. This serves to improve the convenience of input by the player. Furthermore, as for “trip to hot spring” in the item of the going-out destination, in relation to the main character already selected, it is required that a “trip to hot spring” event has been generated with the raising function to release game rendition. In the case where the game rendition for “trip to hot spring” has not been released in relation to the main character, it is not possible to select “trip to hot spring”. In the case where it is not possible to select “trip to hot spring” for the main character, the icon corresponding to “trip to hot spring” is displayed in a grayed-out manner. Alternatively, it is possible to make it possible to recognize that it is not possible to select “trip to hot spring” by, for example, attaching a badge icon indicating that “trip to hot spring” has not been released. As described above, in the going-out/event-detail selection screen, restrictions arise concerning selection of the going-out destination if a specific event has not been released with the raising function for each character. This serves to give a motivation for using various characters with the raising function.

Furthermore, a viewing start button 554 and a back button 555 are provided in the going-out/event-detail selection screen. When a tap input has been performed on the viewing start button 554, the state changes to a rendition executing state, in which game rendition is executed on the basis of the content selected by the player in each of the character selection accepting state, the rendition-part selection accepting state, and the execution-pattern selection accepting state (step S204). When a tap input on the back button 555 has been performed in the situation where the going-out/event-detail selection screen is displayed, the state returns to the rendition-part selection accepting state (step S202), and the display screen changes to the rendition-part selection screen.

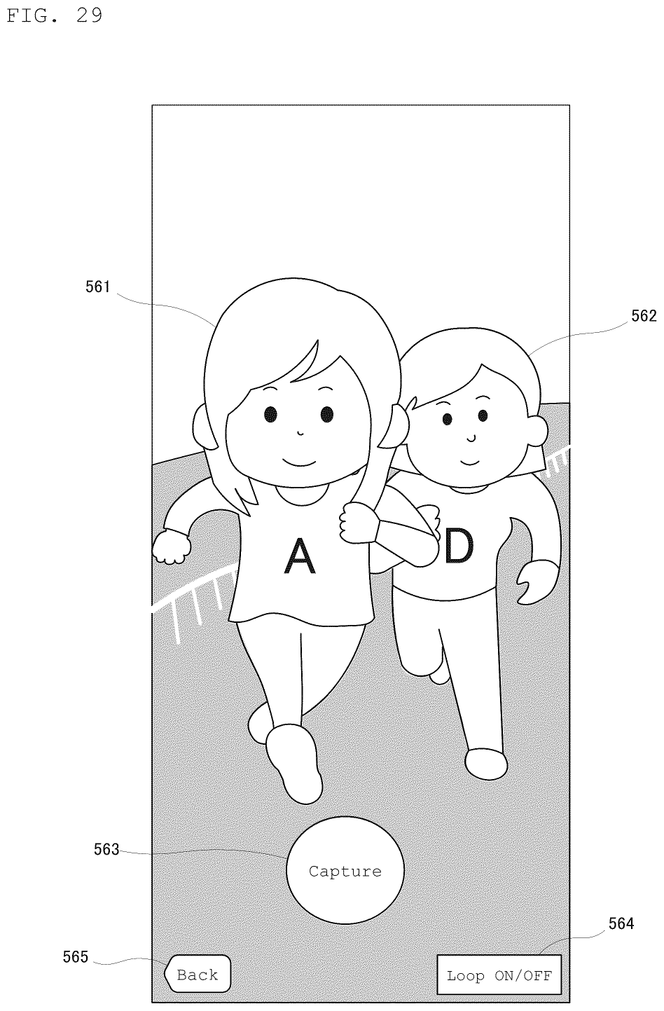

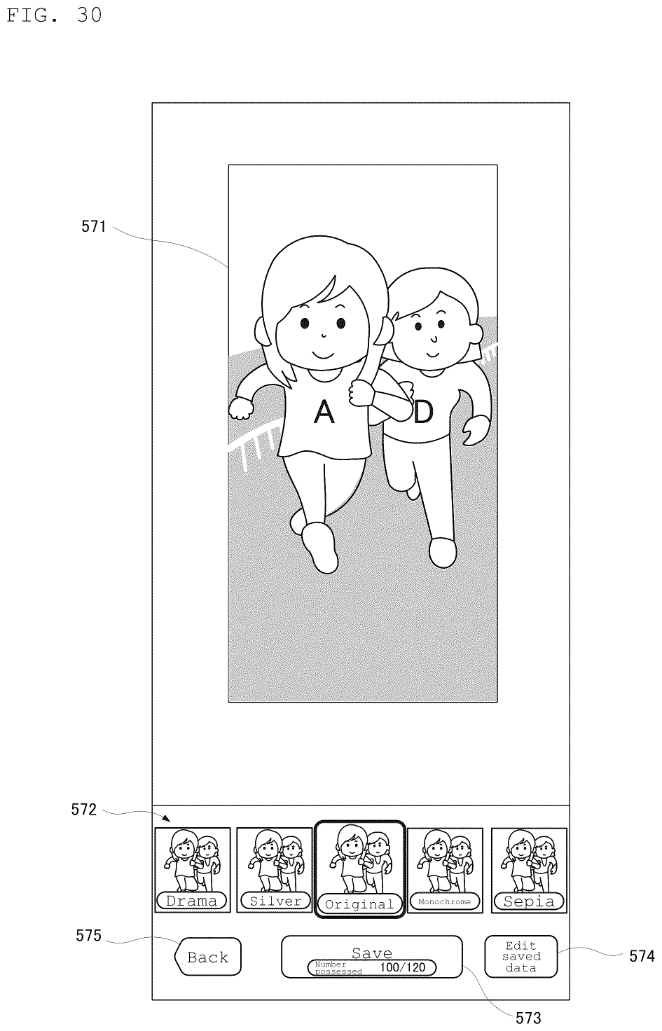

In the rendition executing state, game rendition corresponding to the results of selection of the main character and the rendition execution pattern is executed. In this embodiment, game rendition is executed by reading out rendition material data with the rendition viewing function, shared with the raising function, from the raising-progress-data storage unit 72. FIG. 29 is an illustration showing an example screen displayed while game rendition is being executed with the rendition viewing function. In the example shown in FIG. 29, game rendition is executed such that a main character 561 (character A) and a training partner 562 (character D) perform training. Furthermore, in this embodiment, a photograph button 563 and a loop play button 564 are provided in the screen displayed while game rendition is being executed. When a tap input on the photograph button 563 has been performed, the game rendition being executed is paused, a screenshot is displayed, and the display screen changes to an image confirmation screen shown in FIG. 30. It is possible to switch between ON/OFF of loop play each time a tap input is performed on the loop play button 564. In the case where loop play is ON, returning from the last frame to the first frame of game rendition, game rendition is executed again. Meanwhile, in the case where loop play is OFF, upon the completion of the execution of a series of game rendition, the image of the last frame of the game rendition is displayed as paused. As for processing for drawing frame images constituting game rendition in loop play, the images of the individual frames may be rendered each time loop play is performed, or the images of a series of frames rendered at the time of initial execution of game rendition may be temporarily stored in the storage unit 42 as movie data, and the movie data temporarily stored in the storage unit 42 may be played beginning from the first frame instead of performing rendering processing again at the time of loop play. Furthermore, the ON/OFF switching of loop play with the loop play button 564 is effective both while game rendition is being executed and while game rendition is paused. The arrangement may be such that a seek bar is provided in the screen displayed while game rendition is being executed, making it possible to start game rendition from an arbitrary frame or to rewind game rendition to an arbitrary frame from the first frame to the last frame.

In the image confirmation screen, the image of the screenshot captured is displayed in an image display area 571, as shown in FIG. 30. Furthermore, in this embodiment, it is possible to specify the format of saving, including filtering processing, before saving the captured screenshot image in the image-data storage unit 74 in the situation where the image confirmation screen is displayed. In this embodiment, it is possible to specify one of “retro”, “girly”, “sharp”, “drama”, “silver”, “original”, “monochrome”, “sepia”, “cute”, and “cool” as the saving format. In the image confirmation screen, it is possible to display five kinds of saving formats in a saving-format display area 572 provided in a lower part of the image display area 571. It is possible to perform sliding display and to confirm hidden saving formats by performing horizontal swipe inputs. Furthermore, it is possible to save the captured image as-is by selecting the saving format “original” in the image confirmation screen. Meanwhile, in the case where a saving format other than “original” is specified in the image confirmation screen, an image having been subjected to filtering processing corresponding to the saving format is displayed in the image display area 571, and it is possible to save the image having been subjected to filtering processing in the image-data storage unit 74 by tapping a save button 573 in that state. Note that, in this embodiment, in the case of saving an image having been subjected to filtering processing with a saving format other than “original” specified, the “original” image and the image having been subjected to filtering processing are stored in the image-data storage unit 74 at the time of initial saving. In the state where the “original” image has already been saved in the image-data storage unit 74, only the image having been subjected to filtering processing is additionally saved.

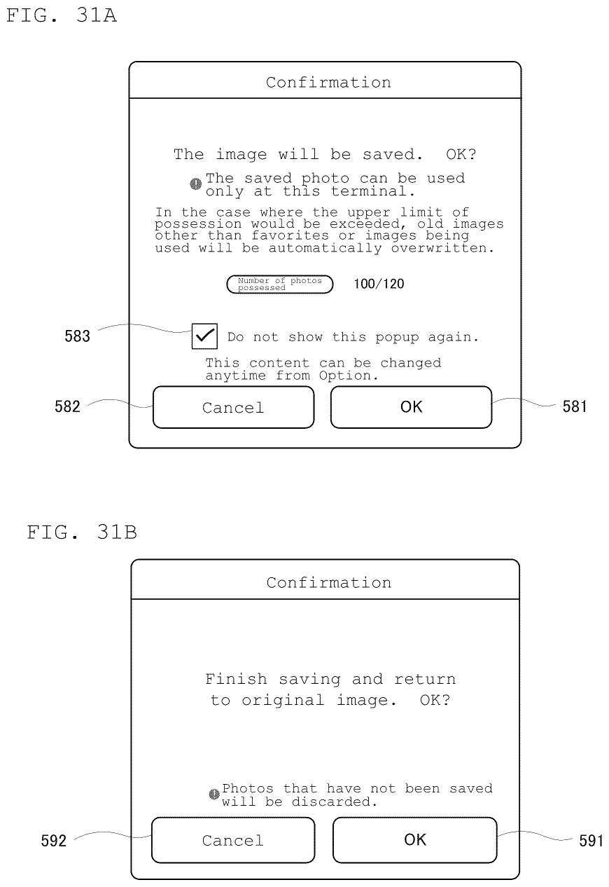

When a tap input on the save button 573 has been performed in the state where the image confirmation screen is displayed, a saving confirmation dialog is displayed, as shown in FIG. 31A. When a tap input on an OK button 581 has been performed in the state where the saving confirmation dialog is displayed, the image displayed in the image display area 571 of the image confirmation screen is saved in the image-data storage unit 74. Upon the completion of image saving, the display screen returns to the image confirmation screen. In the case where a tap input has been performed on a cancel button 582 provided in the saving confirmation dialog, the saving confirmation dialog is closed without saving the image, and the display screen returns to the image confirmation screen.

Furthermore, in this embodiment, the displaying of the saving confirmation dialog may be omitted, and it is possible to switch whether or not to display the saving confirmation dialog by using a checkbox 583 provided in the saving confirmation dialog. For example, in the case where a checkmark is present in the checkbox 583 in the saving confirmation dialog, on the next and later occasions of image saving, by performing a tap input on the save button 573 in the image confirmation screen, the displaying of the saving confirmation dialog is omitted, and the image displayed in the image display area 571 is saved in the image-data storage unit 74.

Furthermore, in this embodiment, an upper limit (e.g., 120) is specified for the number of images that can be saved in the image-data storage unit 74. In the case where an image is to be newly saved in the state where the number of images saved in the image-data storage unit 74 has reached the upper limit, the image to be saved is saved by overwriting the image having the oldest saving date and time. Thus, in this embodiment, by performing a tap input on a saved-data editing button 574 provided in the image confirmation screen, it is possible to display a list of images saved in the image-data storage unit 74 and to delete an arbitrary image or register an arbitrary image as a favorite. The image registered as a favorite is excluded from what may be overwritten, which prevents an accident in which an image not to be deleted is lost as a result of overwrite saving.

Meanwhile, in the case where a tap input on a back button 575 provided in the image confirmation screen has been performed, a finish confirmation dialog shown in FIG. 31B is displayed. In the case where a tap input on an OK button 591 provided in the finish confirmation dialog has been performed, the finish confirmation dialog is closed, and the state returns to the rendition-part selection accepting state (the training-detail selection screen or the going-out/event-detail selection screen) before the start of execution of game rendition. Meanwhile, in the case where a tap input has been performed on a cancel button 592 provided in the finish confirmation dialog, the finish confirmation dialog is closed, and the display screen returns to the image confirmation screen.

Furthermore, in this embodiment, it is possible to close the rendition viewing function by selecting a transition to another game function from a menu bar 600 provided in a lower part of each of the photo-library top screen, the character selection screen, the rendition-part selection screen, the training-detail selection screen, and the going-out/event-detail selection screen.

With the information processing system 10 in the embodiment described above, the rendition viewing function is provided separately from the raising function, and with the rendition viewing function, rendition execution patterns randomly determined with the raising function are presented as selection candidates, which makes it possible for the player to arbitrarily select a rendition execution pattern. In particular, in this embodiment, by including rendition execution patterns that cannot be arbitrarily selected by the player with the raising function and that are determined randomly through lotteries as selection candidates for a rendition execution pattern, by using the rendition viewing function, the player can quickly experience game rendition not yet experienced with the raising function. Therefore, the information processing system 10 in this embodiment serves to improve convenience for experiencing game rendition.

Furthermore, with the information processing system 10 in this embodiment, an input interface that makes it possible to capture a screenshot of game rendition being executed with the rendition viewing function and saving the captured screenshot image is provided. Thus, the information processing system 10 in this embodiment, which makes it possible to save a record of experience of game rendition in the form of a screenshot image, serves to enhance fun concerning the experience of game rendition.

Furthermore, in this embodiment, it is possible to select a main character, which is a character that appears as a main element, and a training partner character, which appears as a sub-element, as characters that appear in game rendition executed with the rendition viewing function. Being a released character possessed by the player is set as a first condition for being selectable as the main character, and being a character corresponding to a support item possessed by the player is set as a second condition for being selectable as the training partner character. Thus, with the information processing system 10 in this embodiment, since there are restrictions concerning game rendition that can be reproduced depending on the status of release of the player's character and the status of possession of support items, it is possible to stimulate the player's motivation for acquiring characters and the player's motivation for acquiring support items.

In this embodiment, the kinds of game rendition that can be executed with the rendition viewing function are limited to game rendition executed in the case where a training or going-out instruction has been issued to the raising subject character with the raising function and game rendition executed in the case where a hot-spring trip event has occurred; however, the kind of game rendition are not limited to the above. For example, the kinds of game rendition that can be executed with the rendition viewing function may include game rendition that occurs randomly in association with a support item and that corresponds to an event unique to the support item, as well as game rendition that is an event generated in accordance with a raising scenario and generated in a prescribed turn in the process of raising and that has a pattern in which the result branches. Furthermore, game rendition that can be executed with the rendition viewing function may be game rendition executed in the case where an infirmary instruction serving as a turn consuming action has been issued, similarly to a training or going-out instruction with the raising function. Furthermore, game rendition that can be executed with the rendition viewing function may be game rendition that occurs with the raising function in response to an instruction for an action that is not a turn consuming action, or game rendition corresponding to an event generated randomly through a lottery in the process of raising. For example, game rendition that can be executed with the rendition viewing function may be game rendition that occurs as an item, a skill, a merit that affects statuses, or the like is acquired in the process of raising or game rendition that is an event corresponding to a raising scenario selected before the start of raising and executed in accordance with the result of selection among alternatives given to the player.

Furthermore, with the rendition viewing function, it may be allowed to view game rendition executed with a game function other than the raising function. For example, in the case where another game function is provided, with which the player selects one character from among released characters possessed by the player and specifies a going-out destination of the selected released character, and game rendition showing going out with the character is executed, the arrangement may be such that, concerning game rendition executed with the other game function, the player is allowed to select a character that appears and a rendering execution pattern and to view game rendition reproduced. Furthermore, in the case where there are a success pattern and a failure pattern in game rendition executed with a game function other than the raising function, the arrangement may be such that, with the rendition viewing function, the player is allowed to view game rendition based on a pattern arbitrarily selected from the success pattern and the failure pattern or to view game rendition based on a pattern determined randomly through a lottery (the lottery may be performed either at the server 20 or the player terminal 40).

Furthermore, with the rendition viewing function, random elements may be involved in the execution of some parts of game rendition. For example, in the case where going-out/event is selected as a rendition part, when “shrine” is specified as the going-out destination, game rendition corresponding to an event of drawing a fortune slip is executed. In the event of drawing a fortune slip, branch patterns that depend on the result of the fortune slip are provided, and it is possible to randomly determine the result of the fortune slip through a lottery. That is, instead of letting the player arbitrarily determine all rendition execution patterns, it is possible to randomly determine some rendition execution patterns through lotteries. Furthermore, the arrangement may be such that while branch patterns concerning the execution of game rendition are determined through lotteries at the server 20 with the raising function, branch patterns concerning the execution of game rendition are determined through lotteries at the player terminal 40. With this arrangement, the opportunities of communication with the server 20 in relation to the rendition viewing function are reduced, which makes it possible to use the function smoothly at the player terminal 40. For example, the arrangement may be such that the lottery for determining the result of a fortune slip in the event of drawing a fortune slip, mentioned earlier, is executed at the server 20 with the raising function and is executed at the player terminal 40 with the rendition viewing function. Alternatively, lotteries concerning the determination of branch patterns may be performed at the server 20 with both the raising function and the rendition viewing function, or lotteries concerning the determination of branch patterns may be performed at the player terminal 40 with both the raising function and the rendition viewing function.

Furthermore, in this embodiment, in the rendition executing state with the rendition viewing function, it is possible to capture a screenshot and to save the captured image. Alternatively, the arrangement may be such that it is possible to save a video of game rendition being executed. Furthermore, in the case where it is possible to save a video of game rendition being executed, the arrangement may be such that it is possible to cut out and save a video of a range arbitrarily specified from the range of the first frame to the last frame. Furthermore, in the case where it is possible to save a video of game rendition being executed, there may be a limit to the length of video (the number of seconds or the number of frames) that can be saved.

Furthermore, the control method in this embodiment is equally applicable to games in which game rendition occurs in the course of game progress and in which game rendition executed involves random elements. Furthermore, the arrangement may be such that the individual functions of the information processing system 10 are provided for other games. For example, the information processing system 10 is applicable to a game of raising a character that participates in a competition in a sport game such as a baseball game or a football game. Furthermore, the information processing system 10 is also applicable to games in other genres, such as pop-idol raising games, card battle games, combat games, action games, battle royale games, and role playing games, in which it is possible to raise game media, such as characters, items, or equipment.

1. A program for a game in which game media are raised, the program causing a computer to function as:
a raising-function providing unit that provides a raising function for presenting selection candidates for instructing an action of a game medium being raised among the game media, determining a rendition execution pattern on the basis of a condition associated with an action selected by the player, and executing game rendition; and
a rendition-viewing-function providing unit that provides a rendition viewing function for letting the player select the game medium and the rendition execution pattern and for executing the game rendition on the basis of the results of selection,
wherein the rendition-viewing-function providing unit presents the rendition execution patterns randomly determined with the raising function as selection candidates, allowing arbitrary selection by the player from among the rendition execution patterns.

2. A program according to claim 1,
wherein the rendition-viewing-function providing unit provides an input interface for capturing a screenshot of the game rendition being executed with the rendition viewing function, making it possible to save the captured screenshot image.

3. A program according to claim 1, wherein:
it is possible to select the game medium that serves as a main element and the game medium that serves as a sub-element as the game media that appear in the game rendition executed with the rendition viewing function; and
a first condition for permitting selection as the main element and a second condition for permitting selection as the sub-element are set in association with each of the game media.

4. An information processing system for a game in which game media are raised, the information processing system comprising:
a raising-function providing unit that provides a raising function for presenting selection candidates for instructing an action of a game medium being raised among the game media, determining a rendition execution pattern on the basis of a condition associated with an action selected by the player, and executing game rendition; and
a rendition-reproducing-function providing unit that provides a rendition viewing function for letting the player select the game medium and the rendition execution pattern and for executing the game rendition on the basis of the results of selection,
wherein the rendition-viewing-function providing unit presents the rendition execution patterns randomly determined with the raising function as selection candidates, allowing arbitrary selection by the player from among the rendition execution patterns.

5. An information processing method for a game in which game media are raised, the information processing method comprising:
a raising-function providing step of providing a raising function for presenting selection candidates for instructing an action of a game medium being raised among the game media, determining a rendition execution pattern on the basis of a condition associated with an action selected by the player, and executing game rendition; and
a rendition-viewing-function providing step of providing a rendition viewing function for letting the player select the game medium and the rendition execution pattern and for executing the game rendition on the basis of the results of selection,
wherein, in the rendition-viewing-function providing step, the rendition execution patterns randomly determined with the raising function are presented as selection candidates, allowing arbitrary selection by the player from among the rendition execution patterns.
